(19) United States
(12) Patent Application Publication
(10) Pub. No.: US 2010/0131469 A1
(43) Pub. Date: May 27, 2010

(54) STORAGE MANAGEMENT DEVICE AND FILE DELETION CONTROL METHOD

(75) Inventor: Shoko Umemura, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/363,878

(22) Filed: Feb. 2, 2009

(30) Foreign Application Priority Data
Nov. 21, 2008 (JP) 2008-298709

(51) Int. Cl. G06F 17/30

(52) U.S. Cl. 707/661; 707/E17.009

(57) ABSTRACT

A storage management device is interposed between a file management device and a plurality of storage resources which are possessed by a storage system. The storage management device receives a file access request from the file management device, and, in response to the file access request, accesses any one of files stored in any one of the plurality of storage resources possessed by the storage system. And the storage management device includes a file copy module and a deletion processing module. The file copy module performs file copy processing in which files are copied between the storage resources. And if the result of the file copy processing is that, among the plurality of storage resources, there is some storage resource which can be deleted, which is a storage resource upon which only files which can be deleted are stored, the deletion processing module performs deletion processing of that storage resource which can be deleted.

### CROSS-REFERENCE TO PRIOR APPLICATION

This application relates to and claims the benefit of priority from Japanese Patent Application number 2008-298709, filed on Nov. 21, 2008, the entire disclosure of which is incorporated herein by reference.

### BACKGROUND

The present invention generally relates to deletion of files which are stored upon a storage system.

Due to legal regulations, for example, there are some files which it is compulsory to store for a fixed period of time. This type of file should be deleted do avoid being referred to again, after it has been archived and stored for the fixed period of time.

Shredding processing is one type of deletion processing. Shredding processing is performed for each file which is to be a subject for shredding.

When deleting data, in order for the data which is the subject for deletion not to remain as magnetic information upon the hard disk drive, it is necessary to overwrite some arbitrary data over that data which is the subject for deletion. For example, in Japanese Laid-Open Patent Publication 2007-11522, there is proposed a method of, when a host issues a complete deletion command for data which is stored upon a hard disk drive storage device and which is to be a subject for deletion, deleting the subject data for deletion by data units, by overwriting arbitrary data over that subject data for deletion by data units.

### SUMMARY

If there are a plurality of files which are to be subjects for shredding, the file management device (for example, a file server) performs shredding processing upon each of these shredding subject files. In this case, a long time might be taken until the shredding processing is completed upon all of the shredding subject files, and also a high load is imposed upon the file management device. This type of problem can also occur in a similar manner when some type of deletion processing other than shredding processing is being performed. This type of problem is considered to become particularly great, the greater the number of deletion subject files becomes. The reason why is that, the greater the number of the deletion subject files, the greater does the number of times that deletion processing must be performed become.

Moreover, this type of problem is considered to be particularly prominent, when shredding processing is employed as the deletion processing. The reason why is that, with shredding processing, the dummy data is written a plurality of times, and this generally requires a longer period of time, and imposes a higher load, than other types of deletion processing.

Accordingly, one object of the present invention is to alleviate the load upon a file management device.

Another object of the present invention is to shorten the time period required for deletion processing of a plurality of files.

A storage management device is interposed between a file management device and a plurality of storage resources which are possessed by a storage system. The storage management device receives a file access request from the file management device, and, in response to the file access request, accesses any one of files stored in any one of the plurality of storage resources possessed by the storage system. And the storage management device includes a file copy module and a deletion processing module. The file copy module performs file copy processing in which files are copied between the storage resources. And if the result of the file copy processing is that, among the plurality of storage resources, there is a storage resource which can be deleted, which is a storage resource upon which only files which can be deleted are stored, the deletion processing module performs deletion processing of the storage resource which can be deleted.

The storage management device may be a computer which is coupled to the storage system, or may be a device which is embedded in the storage system. The storage management device is a device which functions as, for example, a NAS (Network Attached Storage) head.

The plurality of storage resources may be, for example, a plurality of physical volumes and a plurality of logical volumes. The physical volumes are constituted by one or more physical storage devices, and constitute the basis for one or more logical volumes. And the storage management device performs the following processes (A) through (G):

(A) a first physical volume and a second physical volume are determined from a plurality of physical volumes possessed by a storage system and first file copy processing is performed, and, in said first file copy processing, data element groups which make up all non-deletion subject files are read from said first physical volume, and said data element groups which have been read are overwritten over data element groups which make up deletion subject files upon said second physical volume;

(B) if the result of said first file copy processing is that only files which can be deleted are stored upon said first physical volume, shredding processing is performed upon said first physical volume as a physical volume unit;

(C) after (B) above, if there are any further physical volumes among said plurality of physical volumes which satisfy the condition to be said first and said second physical volumes, (A) above is performed; while, if there are no further physical volumes among said plurality of physical volumes which satisfy the condition to be said first and said second physical volumes, (D) below is performed;

(D) a first logical volume and a second logical volume are determined from a plurality of logical volumes and second file copy processing is performed, and, in said second file copy processing, data element groups which make up all non-deletion subject files are read from said first logical volume, and said data element groups which have been read are overwritten over data element groups which make up deletion subject files upon said second logical volume;

(E) if the result of said second file copy processing is that only files which can be deleted are stored upon said first logical volume, shredding processing is performed upon said first logical volume as a logical volume unit;

(F) after (E) above, if there are any further logical volumes among said plurality of logical volumes which satisfy the condition to be said first and said second logical volumes, (D) above is performed; while, if there are no further logical volumes among said plurality of logical volumes which satisfy the condition to be said first and said second logical volumes, (G) below is performed; and

(G) deletion processing by file units is performed upon any deletion subject files which have not been deleted by either (B) above or (E) above.

The second physical volume is a physical volume which has an overwritable capacity which is greater than or equal to the remaining used capacity for the first physical volume. And the second logical volume is a logical volume which has an overwritable capacity which is greater than or equal to the remaining used capacity for the first logical volume. By overwritable capacity is meant either the deletable capacity, which is the total volume of the deletion subject files, or the sum of that deletable capacity and the empty capacity. By remaining used capacity is meant the total volume of the non-deletion subject files. And by files which can be deleted is meant either deletion subject files, or non-deletion subject files which have been the source for being read.

### BRIEF DESCRIPTION OF THE DRAWINGS

FIG. 1 shows an example of the structure of a computer system according to an embodiment of the present invention;

FIG. 2 shows a summary of an embodiment of the present invention;

FIG. 3 shows subtraction of the total amount of files which must be shredded by file units, in this embodiment;

FIG. 4 shows a summary of overwriting processing performed by PVOL units;

FIG. 5 shows the results of the overwriting processing shown in FIG. 4;

FIG. 6 shows that PVOL shredding has been performed upon a PVOL 2222, and shows a summary of overwriting processing by LVOL units;

FIG. 7 shows the results of the overwriting processing shown in FIG. 6;

FIG. 8 shows that LVOL shredding has been performed upon an LVOL fff;

FIG. 9 shows that file shredding has been performed upon a file J;

FIG. 10 shows computer programs and information which are stored in a memory 111 of an archive management server 101;

FIG. 11 shows computer programs and information which are stored in a memory 131 of a storage business server 103;

FIG. 12 shows an example of the structure of a file information table T1;

FIG. 13 shows an example of the structure of a volume correspondence information table T4;

FIG. 14A shows an example of the structure of a physical shredding management table T3P;

FIG. 14B shows an example of the structure of a logical shredding management table T3L;

FIG. 15A shows an example of the structure of a PVOL information table T2P;

FIG. 15B shows an example of the structure of an LVOL information table T2L;

FIG. 16 shows a summary of processing flow for creating the tables T1, T4, T3P, T3L, T2P, and T2L;

FIG. 17 shows a summary of processing flow performed in this embodiment;

FIG. 18 shows the flow of a processing stage #1;

FIG. 19 shows the table T3P after it has been updated by a step S1707 of FIG. 18;

FIG. 20 shows the table T2P after it has been updated by the step S1707 of FIG. 18;

FIG. 21 shows the table T3L after it has been updated by the step S1707 of FIG. 18;

FIG. 22 shows the table T2L after it has been updated by the step S1707 of FIG. 18;

FIG. 23 shows the flow of a processing stage #2;

FIG. 24 shows the table T2P after it has been updated by a step S1803 of FIG. 23;

FIG. 25 shows the table T3L after it has been updated by the step S1803 of FIG. 23;

FIG. 26 shows the table T2P after it has been updated by the step S1803 of FIG. 23;

FIG. 27 shows the table T2L after it has been updated by the step S1803 of FIG. 23;

FIG. 28 shows the flow of a processing stage #3;

FIG. 29 shows the table T3L after it has been updated by a step S1904 of FIG. 28;

FIG. 30 shows the table T2L after it has been updated by the step S1904 of FIG. 28

FIG. 31 shows the flow of a processing stage #4;

FIG. 32 shows the table T3L after it has been updated by a step S2003 of FIG. 31;

FIG. 33 shows the table T2L after it has been updated by the step S2003 of FIG. 31;

FIG. 34 shows the flow of a processing stage #5;

FIG. 35 shows a variant embodiment of the table T2P; and

FIG. 36 shows an example of how a plurality of shredding subject files are overwritten with a plurality of non-shredding subject files.

### DETAILED DESCRIPTION

In the following, embodiments of the present invention will be explained with reference to the drawings. It should be understood that although, in the following explanation, in order to avoid redundant explanation, as appropriate, processing may be explained while taking a computer program as the grammatical subject, actually this processing is performed by a processor which executes that computer program.

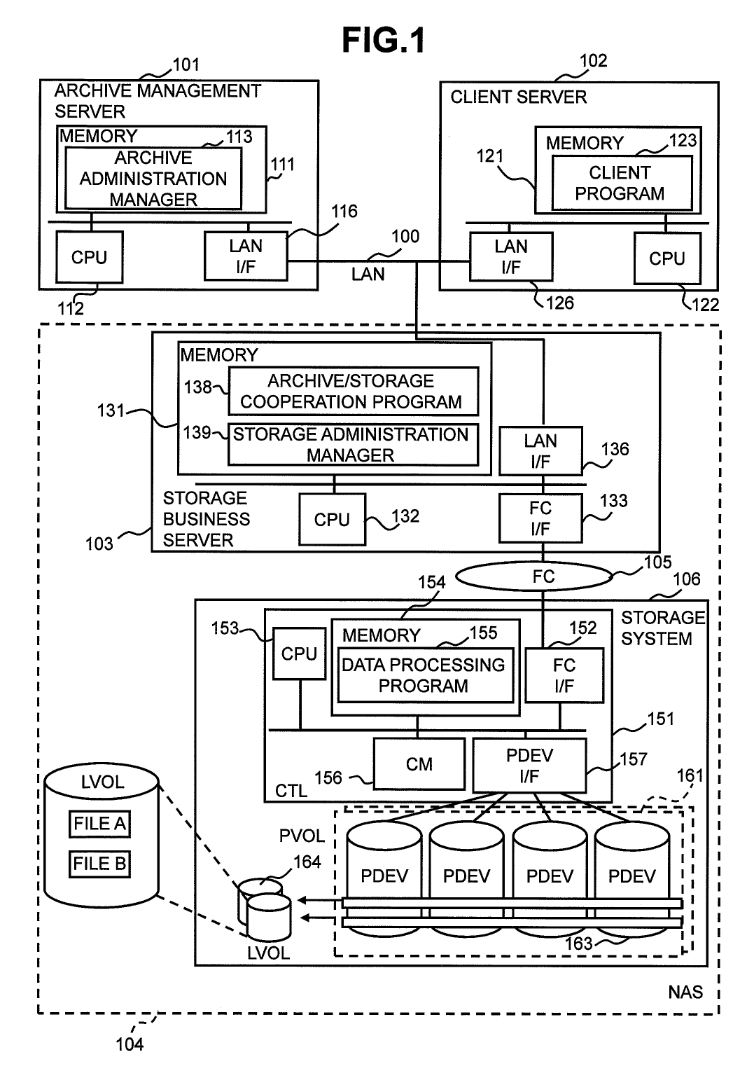

FIG. 1 shows an example of the structure of a computer system according to an embodiment of the present invention. It should be understood that, in the following explanation, “interface device” is abbreviated as “I/F”.

A client server 102, an archive management server 101, and a storage business server 103 are connected to a LAN (Local Area Network) 100. The storage business server 103 and a storage system 106 are connected to a FC (Fiber Channel) network 105. The storage business server 103 and the storage system 106 constitute a NAS 104. It would also be acceptable to employ some other type of network for at least one of the LAN 100 and the FC network 105. The client server 102 communicates with the archive management server 101. In concrete terms, for example, the client server 102 transmits requests such as archive creation requests or the like to the archive management server 101. The client server 102 is a computer which comprises hardware resources such as a memory 121, a CPU (Central Processing Unit) 122, a LAN I/F 126, and so on. A client program 123, for example, is stored in the memory 121 as a computer program which is executed by the CPU 122. This client program transmits requests such as archive creation requests and so on to the archive management server 101.

The archive management server 101 is a type of file management device, and processes requests from the client server 102. For example, in response to an archive creation request from the client server 102, the archive management server 101 may create an archive file. Moreover, the archive management server 101 transmits to the storage business server 103 a file write request in which archive file is taken as a subject to be written. The archive management server 101 is a computer which comprises hardware resources such as a memory 111, a CPU (Central Processing Unit) 112, a LAN I/F 116, and so on. An archive administration manager 113, for example, is stored in the memory 111 as a computer program which is executed by the CPU 112. This archive administration manager 113 will be explained hereinafter.

The storage business server 103 is one example of a storage management device. In response to a file access request from the archive management server 101, this storage business server 103 transmits a block access request to the storage system 106. For example, in response to a file write request from the archive management server 101, the storage business server 103 transmits to the storage system 106 a block write request in which a group of data element making up the archive file which is the subject to be written is specified as the subject to be written (for example, a request in which a LUN (Logical Unit Number) and a LBA (Logical Block Address) are included). The storage business server 103 is a computer which comprises hardware resources such as a memory 131, a CPU (Central Processing Unit) 132, a LAN I/F 136, an FC I/F 133, and so on. The LAN I/F 136 is an interface device which controls communication via the LAN 105. And the FC I/F 133 is an interface device which controls communication via the FC network 105. An archive/storage cooperation program 138 and a storage administration manager 139, for example, are stored in the memory 131 as computer programs which are executed by the CPU 132. This archive/storage cooperation program 138 and storage administration manager 139 will be explained hereinafter.

The storage system 106 comprises a controller (CTL) 151 and a plurality of physical volumes (PVOLs) 161.

The physical volumes 161 are RAID groups according to some predetermined RAID (Redundant Array of Independent (or Inexpensive) Disks) level. Each of these physical volumes 161 includes a plurality of physical storage devices (PDEVs) 163. Various types of devices such as hard disk drives (HDDs), flash memory devices, or the like may be employed as the PDEVs 163.

One or a plurality of logical volumes (LVOLs) 164 are defined on the basis of the plurality of PDEVs 163 possessed by a physical volume 161 (i.e. based upon the storage space of the physical volume 161). An LVOL 164 is a logical storage device. Data element groups which are structured as files are stored on the LVOL 164. The term “data element” as used in the explanation of this embodiment means a block of data stored in any one of a plurality of blocks (storage areas) which make up the LVOL 164.

The CTL 151 receives a block access request from the storage business server 103, and, in response to this block access request, accesses the PDEVs 163 which constitute the basis for the LVOL specified in this block access request (for example, the LVOL which corresponds to the LUN specified by that request). The CTL 151 may comprise, for example, an FC I/F 152, a memory 154, a CPU 153, a cache memory (CM) 156, and a PDEV I/F 157. The PDEV I/F 157 is an interface device which controls communication with the PDEVs 163. Data element groups which are transmitted and received between the storage business server 103 and the PDEVs 163 are temporarily stored in the CM 156. A data processing program 155, for example, is stored in the memory 154 as a computer program which is executed by the CPU 153. This data processing program 155 processes block access requests. For example, in response to a block write request, the data processing program 155 temporarily stores the data element group which is the subject for being written in the CM 156, and writes this data element group which is the subject for being written from the CM 156 into the LVOL 164 which is the destination for writing. Moreover, for example, in response to a block read request, the data processing program 155 transmits the file which is the subject for being read, which is made up from data element groups which are subjects for being read, to the storage business server 103, by reading out the data element groups which are the subjects for being read from the LVOL 164 which is the source for reading, temporarily storing them in the CM 156, and then acquiring these data element groups which are the subjects for being read from the CM 156.

In the following, a summary of the processing performed in this embodiment will be explained. It should be understood that, in the following explanation, the term “VOL” (volume) will be used to refer to a volume which can be either a PVOL or an LVOL. Moreover, in the following explanation, the term “file” refers to an archive file.

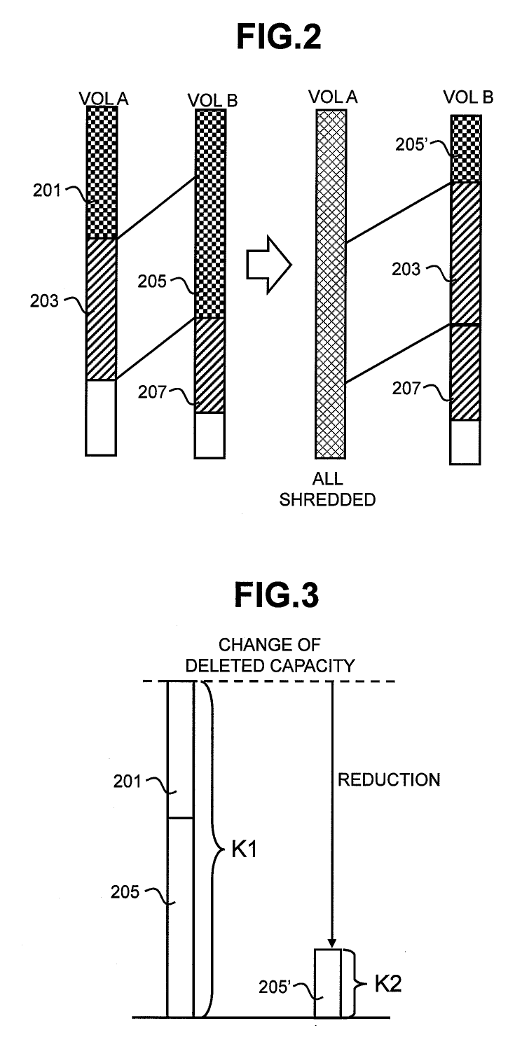

As, for example, shown at the left side of FIG. 2, a volume VOL A and a volume VOL B are present. A “shredding subject” file group 201 which is to be a subject of shredding, and a “non-shredding subject” file group 203 which is not to be a subject of shredding, are stored on VOL A. And a shredding subject file group 205 and a non-shredding subject file group 207 are stored on VOL B.

In this embodiment, a volume which has an overwritable capacity which is greater than or equal to the remaining used capacity of some certain volume is taken as being an aggregation destination volume, while that certain volume is taken as being an aggregation source volume. According to the example in FIG. 2, since VOL B has an overwritable capacity which is greater than or equal to the remaining used capacity of VOL A, accordingly VOL B is taken as an aggregation destination volume, while VOL A is taken as an aggregation source volume. A “aggregation destination volume” is a volume which constitutes a destination for aggregation of files, while a “aggregation source volume” is a volume upon which files which are to be aggregated are stored. Moreover, the “remaining used capacity” is the size of the group of files which is not to be shredded (the non-shredding subject file group). And the “overwritable capacity” may be the deletable capacity, which is the size of the group of files which are to be shredded (the shredding subject file group), or may be the sum of the deletable capacity and the empty capacity (the empty capacity=the capacity of the volume−(the deletable capacity+the remaining used capacity). In this embodiment, the overwritable capacity is the deletable capacity.

As shown at the right side of FIG. 2, the non-shredding subject file group 203 which is stored upon the aggregation source volume VOL A is overwritten over the shredding subject file group 205 which is stored upon the aggregation destination volume VOL B. Since, due to this, the non-shredding subject file group 203 comes to be present upon the aggregation destination volume VOL B, accordingly the non-shredding subject file group 203 upon the aggregation source volume VOL A becomes unnecessary. Consequently, the file groups which are present upon the aggregation source volume VOL A now consist only of file groups which can be deleted; in concrete terms, these are now only the non-shredding subject file group 203 which has become useless, and the shredding subject file group 201.

Thus, as shown at the right side of FIG. 2, shredding processing is performed upon the aggregation source volume VOL A for the whole volume as a unit. Thereafter, shredding processing is performed upon the shredding subject file group 205′ on the aggregation destination volume VOL B (i.e. upon that group of files, among the shredding subject file group 205, which have not been overwritten with the non-shredding subject file group 203) in units of files, i.e. shredding processing is performed upon each of the files which makes up this file group.

According to the above processing, the total amount of files upon which shredding processing is to be performed in file units is obtained by subtracting K2 as described below from K1 as described below, as shown in FIG. 3.

K1=(size of shredding subject file group 201)+(size of shredding subject file group 205)

K2=size of shredding subject file group 205′=(size of shredding subject file group 205−(size of non-shredding subject file group 203)

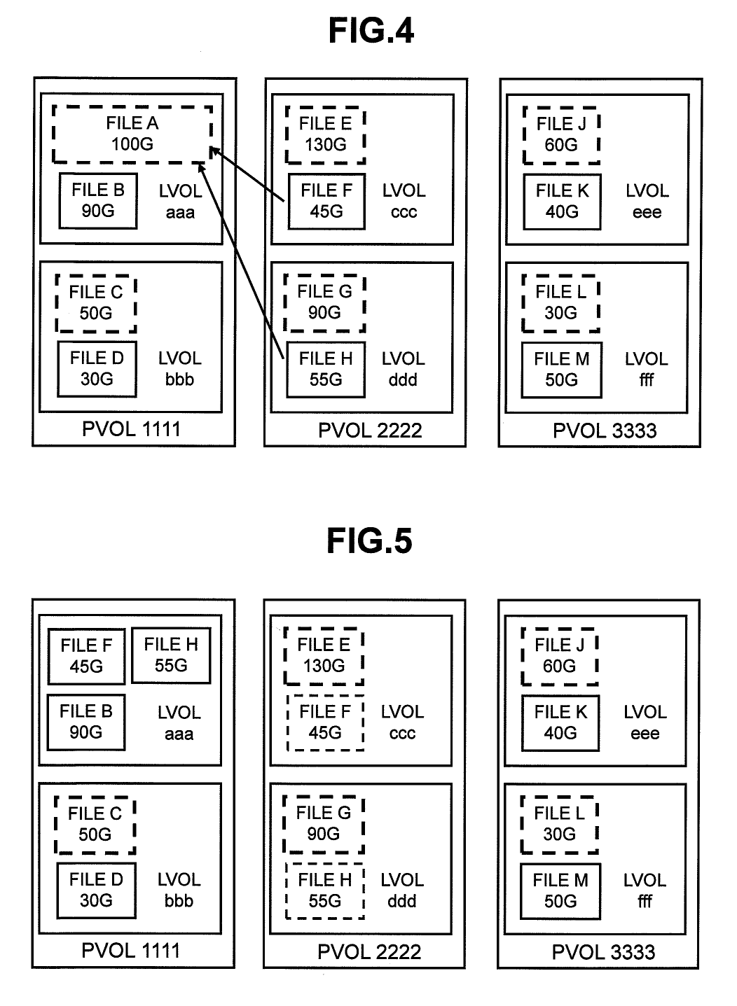

The overwriting processing and the shredding processing described above are performed preferentially from the larger units of storage resource downwards. In other words, in this embodiment, first, the overwriting processing and shredding processing are performed by PVOL units; thereafter, the overwriting processing and shredding processing are performed by LVOL units; and, finally, the overwriting processing and shredding processing are performed by file units upon the remaining shredding subject files which have not yet been deleted. In the following, a concrete example will be explained with reference to FIGS. 4 through 9.

As shown in FIG. 4, a PVOL 1111 constitute the basis for LVOL aaa and LVOL bbb. And a PVOL 2222 constitutes the basis for LVOL ccc and LVOL ddd. Moreover, a PVOL 3333 constitutes the basis for LVOL eee and LVOL fff. A file A (100 G (gigabytes)) and a file B (90 G) are stored upon the LVOL aaa. A file C (50 G) and a file D (30 G) are stored upon the LVOL bbb. A file E (130 G) and a file F (45 G) are stored upon the LVOL ccc. A file G (90 G) and a file H (55 G) are stored upon the LVOL ddd. A file J (60 G) and a file K (40 G) are stored upon the LVOL eee. And a file L (30 G) and a file M (50 G) are stored upon the LVOL fff. First, it is decided whether not it is possible to perform any overwriting processing and shredding processing in PVOL units. Among the files A through M shown in FIG. 4, the files A, C, E, G, J, and L which are marked with dashed boxes are files which are to be subjected to shredding, while the other files are files which are not to be subjected to shredding. Accordingly, as shown in FIG. 4, the situation is as described below:

PVOL 1111: remaining used capacity (120 G), deletable capacity (150 G);

PVOL 2222: remaining used capacity (100 G), deletable capacity (220 G);

PVOL 3333: remaining used capacity (90 G), deletable capacity (90 G);

Due to this situation, a PVOL pair exists which satisfies the condition to be an aggregation source PVOL and an aggregation destination PVOL (i.e., a pair consisting of some certain PVOL and a PVOL having a deletable capacity which is greater than or equal to the remaining used capacity of that certain PVOL). In concrete terms, if the PVOL 2222 is taken as being the aggregation source PVOL, then the PVOL 1111, which has a deletable capacity (150 G) which is greater than or equal to the remaining used capacity (100 G) of the PVOL 2222, may be taken as being the aggregation destination PVOL.

The total of the sizes of the two non-shredding subject files F and L upon the aggregation source PVOL 2222 is 100 G, which is the same size as that of the shredding subject file A (100 G) upon the aggregation destination PVOL 1111. Thus, as shown in FIG. 4, the two non-shredding subject files F and H upon the aggregation source PVOL 2222 are overwritten over the single shredding subject file A upon the aggregation destination PVOL 1111. When this is done, the two non-shredding subject files F and H upon the aggregation source PVOL 2222 become unnecessary files, as shown by the dashed boxes in FIG. 5. Accordingly, now all of the files E, F, G, and H which are stored upon the aggregation source PVOL 2222 are files which can be deleted.

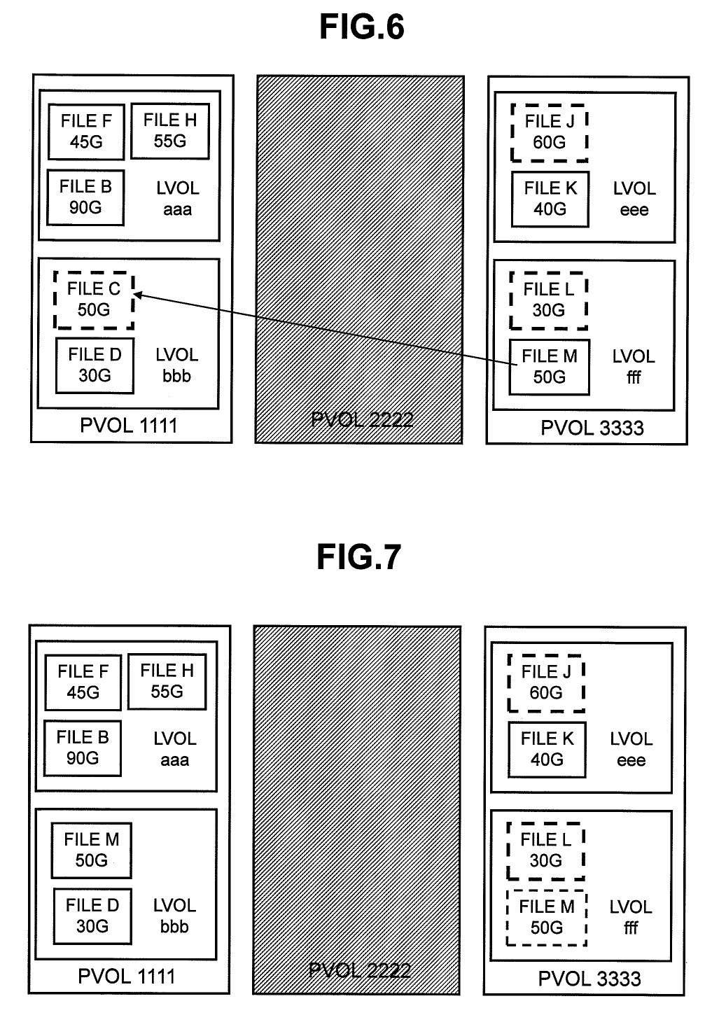

Thus, as shown in FIG. 6, shredding processing in PVOL units (hereinafter termed “PVOL shredding”) is performed upon the aggregation source PVOL 2222.

Next, it is decided for a second time whether or not it is possible to perform overwriting processing and shredding processing by PVOL units. When PVOL shredding as described above has been performed upon the aggregation source PVOL 2222, as shown in FIG. 6, the situation is as described below:

PVOL 1111: remaining used capacity (220 G), deletable capacity (50 G);

PVOL 2222: remaining used capacity (0 G), deletable capacity (0 G);

PVOL 3333: remaining used capacity (90 G), deletable capacity (90 G).

Due to this situation, there is no PVOL pair which satisfies the condition to be an aggregation source PVOL and an aggregation destination PVOL.

Thus, next, it is decided whether not it is possible to perform any overwriting processing and shredding processing in LVOL units. As shown in FIG. 6, the situation is as described below:

LVOL aaa: remaining used capacity (190 G), deletable capacity (0 G);

LVOL bbb: remaining used capacity (30 G), deletable capacity (50 G);

LVOL ccc: remaining used capacity (0 G), deletable capacity (0 G);

LVOL ddd: remaining used capacity (0 G), deletable capacity (0 G);

LVOL eee: remaining used capacity (40 G), deletable capacity (60 G);

LVOL fff: remaining used capacity (50 G), deletable capacity (30 G).

Due to this situation, a LVOL pair exists which satisfies the condition to be an aggregation source LVOL and an aggregation destination LVOL (i.e., a pair consisting of some certain LVOL and a LVOL having a deletable capacity which is greater than or equal to the remaining used capacity of that certain LVOL). In concrete terms, if the LVOL fff is taken as being the aggregation source LVOL, the LVOL bbb, which has a deletable capacity (50 G) which is greater than or equal to the remaining used capacity (50 G) of the LVOL fff, may be taken as being the aggregation destination LVOL.

The size of the non-shredding subject file M upon the aggregation source LVOL fff is 50 G, which is the same size as that of the shredding subject file C (50 G) upon the aggregation destination LVOL bbb.

Thus, as shown in FIG. 6, the non-shredding subject file M upon the aggregation source LVOL fff is overwritten over the shredding subject file C upon the aggregation destination LVOL bbb. When this is done, the non-shredding subject file M upon the aggregation source LVOL fff becomes an unnecessary file, as shown by the dashed box in FIG. 7. Accordingly, now all of the files L and M which are stored upon the aggregation source LVOL fff are files which can be deleted.

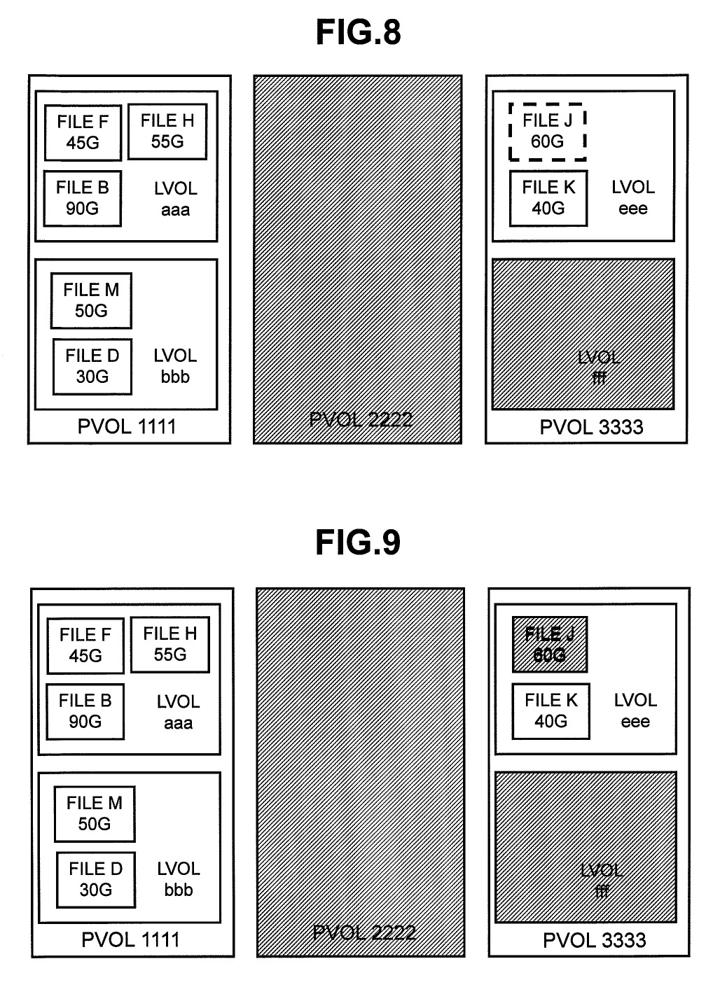

Thus, as shown in FIG. 8, shredding processing in LVOL units (hereinafter termed “LVOL shredding”) is performed upon the aggregation source LVOL fff. Next, it is decided for a second time whether or not it is possible to perform overwriting processing and shredding processing by LVOL units. When LVOL shredding as described above has been performed upon the aggregation source LVOL fff, as shown in FIG. 8, the situation is as described below:

LVOL aaa: remaining used capacity (190 G), deletable capacity (0 G);

LVOL bbb: remaining used capacity (80 G), deletable capacity (0 G);

LVOL ccc: remaining used capacity (0 G), deletable capacity (0 G);

LVOL ddd: remaining used capacity (0 G), deletable capacity (0 G);

LVOL eee: remaining used capacity (40 G), deletable capacity (60 G);

LVOL fff: remaining used capacity (0 G), deletable capacity (0 G).

Due to this situation, there is no LVOL pair which satisfies the condition to be an aggregation source LVOL and an aggregation destination LVOL.

Thus, finally, shredding processing by file units (hereinafter termed “file shredding”) is performed upon the shredding subject files which remain and have not been deleted by either the PVOL shredding process or the LVOL shredding process. In concrete terms, as shown in FIG. 9, file shredding is performed upon the shredding subject file J upon the LVOL eee.

According to the above explanation, PVOL shredding or LVOL shredding is performed after file overwriting processing (i.e. copying processing) has been performed, and file shredding is only performed upon those shredding subject files which are not deleted by the PVOL and LVOL shredding. Although the file shredding is performed by the archive management server 101, the PVOL shredding and the LVOL shredding are performed by the storage business server 103. Due to this, the load upon the archive management server 101 is alleviated.

Furthermore, according to the above explanation, as a result of the file overwriting processing, the areas in use upon the aggregation source PVOL and the aggregation source LVOL (for example, the areas in which are stored data elements which make up the non-shredding subject files which are not to be deleted) are eliminated, and consequently it becomes possible to perform shredding processing with one action upon the entire PVOL or the entire LVOL. In other words, efficient shredding processing becomes possible. Due to this, it is possible to anticipate that the time period required for performing shredding processing upon all of the shredding subject files will become shorter, than if the archive management server 101 were to perform file shredding upon each of the shredding subject files. This benefit may be anticipated to be the greater, the greater is the number of the shredding subject files.

In the following, this embodiment will be explained in more detail.

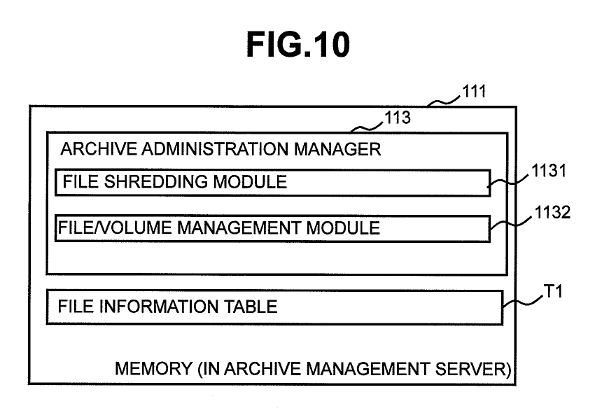

FIG. 10 shows the computer programs and information which are stored in the memory 111 of the archive management server 101.

A file information table T1 is among the information stored in the memory 111. And, as previously described, the archive administration manager 113 is among the computer programs stored therein. The archive administration manager 113 includes a file shredding module 1131 and a file/volume management module 1132.

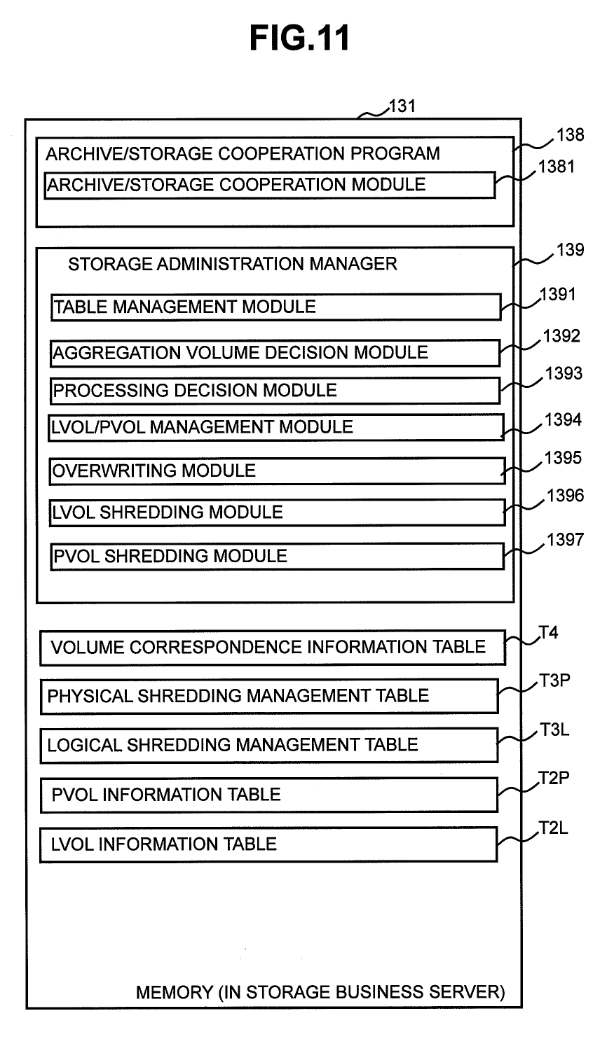

The file shredding module 1131 performs file shredding upon the shredding subject files, on the basis of information (i.e. information related to shredding subject files which remain and have not been deleted) which is transferred from an archive/storage cooperation module 1381 (which will be described hereinafter with reference to FIG. 11).

The file/volume management module 1132 manages which files are stored in which LVOLs by using a file information table T1.

FIG. 11 shows certain computer programs and information which are stored in the memory 131 of the storage business server 103.

Among the information stored in the memory 131, for example, there are a volume correspondence information table T4, a physical shredding management table T3P, a logical shredding management table T3L, a PVOL information table T2P, and an LVOL information table T2L. Among the computer programs stored therein, as previously described, there are the archive/storage cooperation program 138 and the storage administration manager 139. The archive/storage cooperation program 138 includes an archive/storage cooperation module 1381. The storage administration manager 139 includes a table management module 1391, an aggregation volume decision module 1392, a processing decision module 1393, a LVOL/PVOL management module 1394, an overwriting module 1395, an LVOL shredding module 1396, and a PVOL shredding module 1397.

The archive/storage cooperation module 1381 performs information exchange between the storage administration manager 139 and the archive administration manager 113.

The table management module 1391 creates and updates the previously described tables T3P, T3L, T2P, and T2L.

The aggregation volume decision module 1392 refers to the table T2P (T2L), and determines an aggregation source volume and an aggregation destination volume.

The processing decision module 1393 refers to the table T2P (T2L), and decides whether or not to perform overwriting processing and shredding processing by volume units.

The LVOL/PVOL management module 1394 manages creation of the volume correspondence information table T4.

The overwriting module 1395 performs overwriting processing from the aggregation source volume to the aggregation destination volume.

The LVOL shredding module 1396 performs LVOL shredding on the basis of the LVOL information table T2L.

And the PVOL shredding module 1397 performs PVOL shredding on the basis of the PVOL information table T2P.

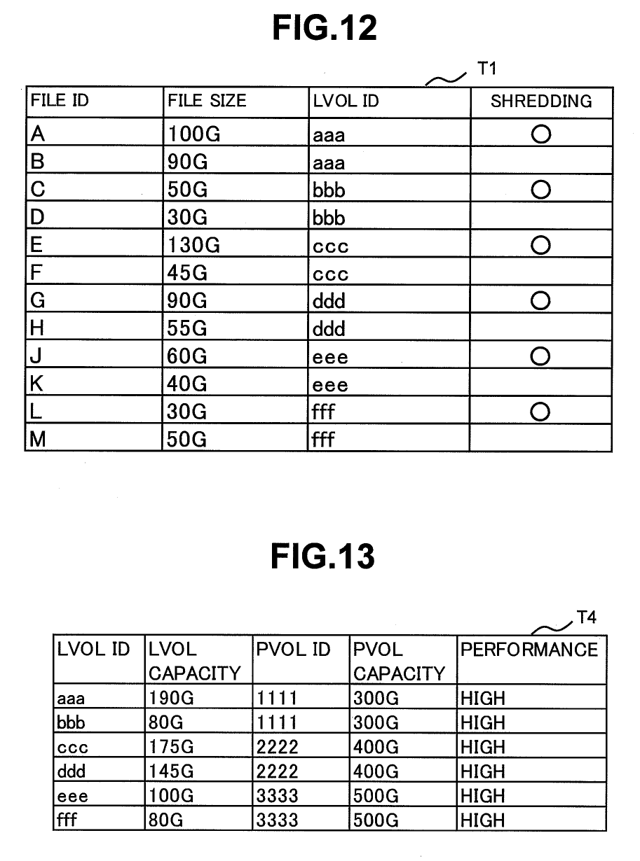

FIG. 12 shows an example of the structure of the file information table T1.

This file information table T1 is a table which contains information related to the management of files by the archive administration manager 113. For example, in this file information table T1, for each file (one file will be taken as an example in the following explanation of FIG. 12, and will be termed the “subject file”), there may be recorded:

(12-1) file ID: the identifier of the subject file;

(12-2) file size: the size of the subject file;

(12-3) LVOL ID: the identifier of the LVOL in which the subject file is stored;

(12-4) shredding subject flag: a flag which shows whether or not the subject file is a subject for shredding (the mark “◯” means that the file is a subject for shredding).

It should be understood that the file ID and the LVOL ID shown in FIG. 12 correspond to the file IDs (for example “A”) and the LVOL IDs (for example “aaa”) in FIGS. 4 through 9.

FIG. 13 shows an example of the structure of the volume correspondence information table T4.

This volume correspondence information table T4 contains information which specifies the correspondence relationship between the LVOLs and the PVOLs. For example, in this volume correspondence information table T4, for each LVOL (one LVOL will be taken as an example in the following explanation of FIG. 13, and will be termed the “subject LVOL”), there may be recorded:

(13-1) LVOL ID: the identifier of the subject LVOL;

(13-2) LVOL capacity: the storage capacity of the subject LVOL;

(13-3) PVOL ID: the identifier of the PVOL to which the subject LVOL belongs;

(13-4) PVOL capacity: the storage capacity of the PVOL to which the subject LVOL belongs;

(13-5) performance information: information which specifies the performance of the subject LVOL.

The performance of the subject LVOL may, for example, be different according to upon which PVOL consisting of what types of PDEVs it is based. As performance information, for example, there may be three types “high”, “medium”, and “low”. It should be understood that the LVOL IDs and the PVOL IDs shown in FIG. 13 correspond to the LVOL IDs (for example “aaa”) and the PVOL IDs (for example “1111”) in FIGS. 4 through 9.

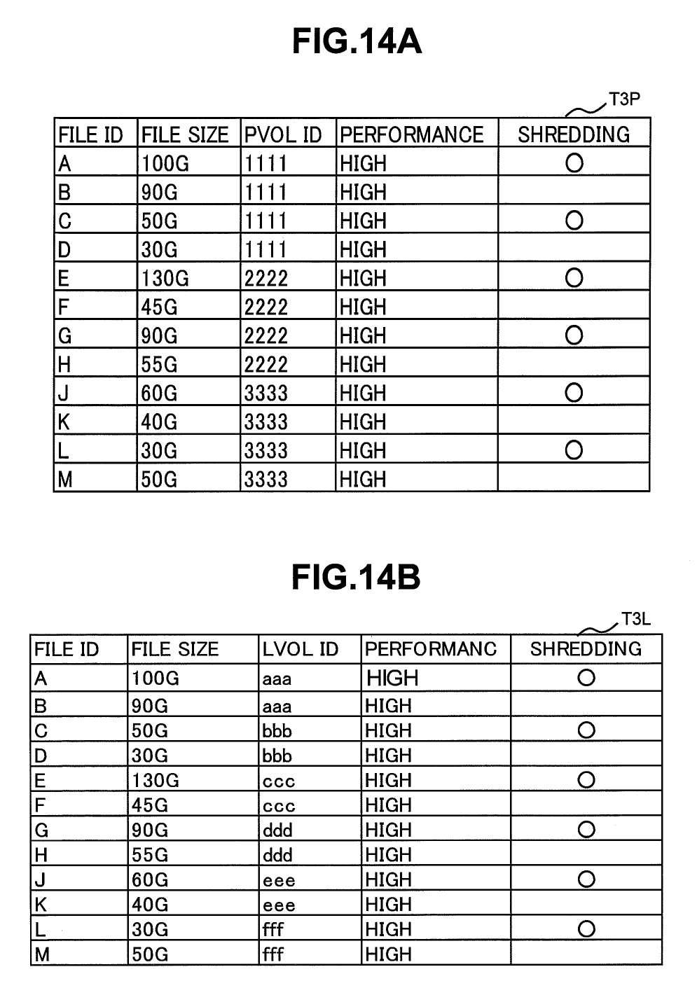

FIG. 14A shows an example of the structure of the physical shredding management table T3P.

This physical shredding management table T3P is a table in which the file information table T1 and the volume correspondence information table T4 are merged, and, in this table, information is recorded which relates to the correspondence between files and PVOLs. For example, in this physical shredding management table T3P, for each file (one file will be taken as an example in the following explanation of FIG. 14A, and will be termed the “subject file”), there may be recorded:

(14A-1) file ID: the identifier of the subject file;

(14A-2) file size: the size of the subject file;

(14A-3) PVOL ID: the identifier of the PVOL upon which the subject file is stored;

(14A-4) performance information: information which specifies the performance of the PVOL upon which the subject file is stored;

(14A-5) shredding subject flag: a flag which shows whether or not the subject file is to be a subject for shredding.

The LVOL ID which corresponds to the subject file is specified from the file information table T1, and the PVOL ID and the performance information which correspond to this specified LVOL ID are specified; and the PVOL ID and performance information which have thus been specified are the PVOL ID and the performance information which correspond to the subject file.

FIG. 14B shows an example of the structure of the logical shredding management table T3L.

This physical shredding management table T3L is also a table in which the file information table T1 and the volume correspondence information table T4 are merged, and, in this table, information is recorded which relates to the correspondence between files and LVOLs. Accordingly, the structure of this logical shredding management table T3L is almost the same as the structure of the physical shredding management table T3P described above. In other words, for example, in this physical shredding management table T3L, for each file (one file will be taken as an example in the following explanation of FIG. 14B, and will be termed the “subject file”), there may be recorded:

(14B-1) file ID: the identifier of the subject file;

(14B-2) file size: the size of the subject file;

(14B-3) LVOL ID: the identifier of the LVOL upon which the subject file is stored;

(14B-4) performance information: information which specifies the performance of the LVOL upon which the subject file is stored;

(14B-5) shredding subject flag: a flag which shows whether or not the subject file is to be a subject for shredding.

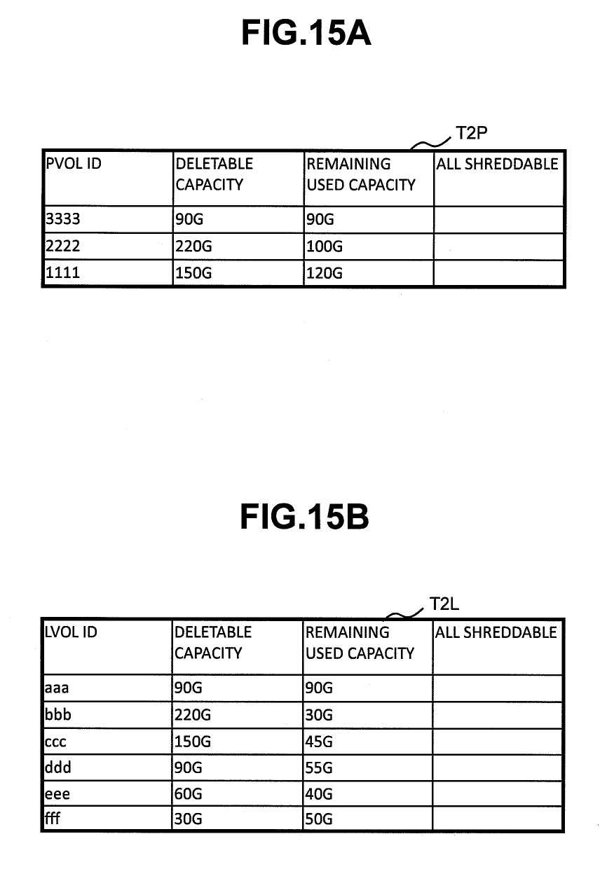

FIG. 15A shows an example of the structure of the PVOL information table T2P. This PVOL correspondence information table T2P is a table which is created based upon the physical shredding management table T3P, and is a table in which information related to the various PVOLs is recorded. For example, in this PVOL correspondence information table T2P, for each PVOL (one PVOL will be taken as an example in the following explanation of FIG. 15A, and will be termed the “subject PVOL”), there may be recorded:

(15A-1) PVOL ID: the identifier of the subject PVOL;

(15A-2) deletable capacity: the total of the sizes of all the shredding subject files within the subject PVOL;

(15A-3) remaining used capacity: the total of the sizes of all the non-shredding subject files within the subject PVOL;

(15A-4) performance information: information which specifies the performance of the subject PVOL;

(15A-5) all shreddable flag: a flag which shows whether or not PVOL shredding can be performed upon the subject PVOL.

The file sizes of the shredding subject files and the file sizes of the non-shredding subject files which are stored upon the subject PVOL are specified by referring to the physical shredding management table T3P with the PVOL ID of the subject PVOL as a key, and the deletable capacity and the remaining used capacity are calculated.

FIG. 15B shows an example of the structure of the LVOL information table T2L. This LVOL correspondence information table T2L is a table which is created based upon the logical shredding management table T3L, and is a table in which information related to the various LVOLs is recorded. The structure of this LVOL information table T2L is almost the same as the structure of the PVOL information table T2P. For example, in this LVOL correspondence information table T2L, for each LVOL (one LVOL will be taken as an example in the following explanation of FIG. 15A, and will be termed the “subject LVOL”), there may be recorded:

(15B-1) LVOL ID: the identifier of the subject LVOL;

(15B-2) deletable capacity: the total of the sizes of all the shredding subject files within the subject LVOL;

(15B-3) remaining used capacity: the total of the sizes of all the non-shredding subject files within the subject LVOL;

(15B-4) performance information: information which specifies the performance of the subject LVOL;

(15B-5) all shreddable flag: a flag which shows whether or not LVOL shredding can be performed upon the subject LVOL.

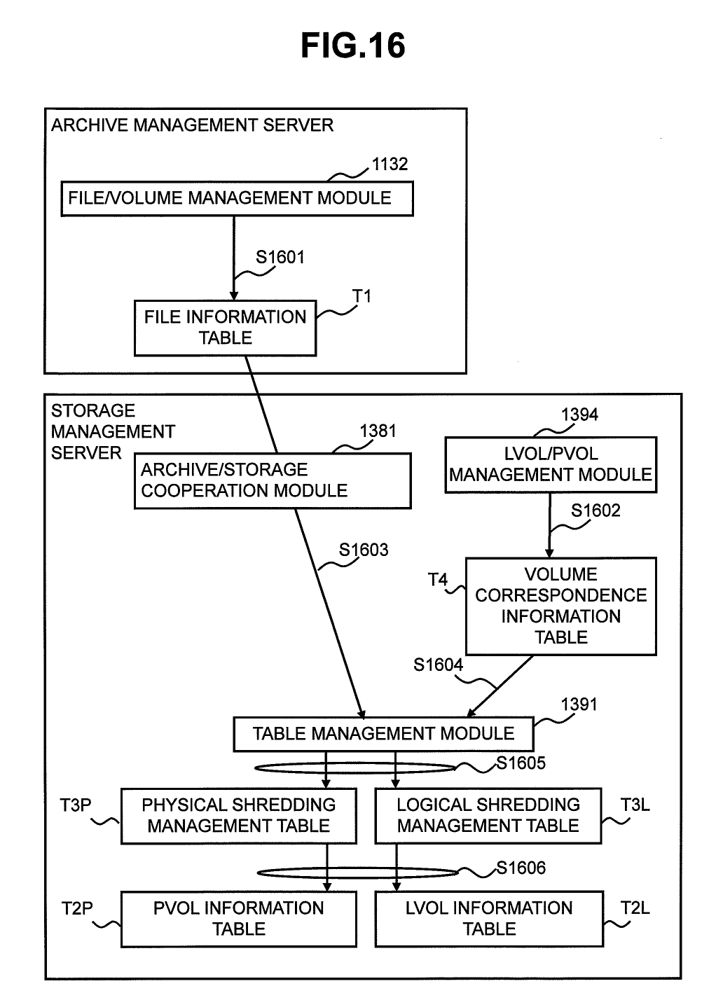

In the following, the flow for creating the tables T1, T4, T3P, T3L, T2P, and T2L will be explained with reference to FIG. 16.

First, the file/volume management module 1132 creates the file information table T1 (a step S1601). In concrete terms, for example, the file/volume management module 1132 may create the file information table T1 when it has been detected that a predetermined number of files which have exceeded the time limit for being stored are present, or in response to a request from the client server 102. The LVOL/PVOL management module 1394 creates the volume correspondence information table T4 (a step S1602). In concrete terms, for example, the LVOL/PVOL management module 1394 may receive structural information which is managed by the CTL 151 of the storage system 106 (for example, information which specifies which LVOLs are created based upon which PVOLs, and which PVOLS are constituted by which PDEVs) from the CTL 151, and may create the volume correspondence information table T4 based upon this structural information.

And the archive/storage cooperation module 1381 receives the information which is recorded in the file information table T1 from the file/volume management module 1132, and transfers this information to the table management module 1391 (a step S1603). Then the table management module 1391 receives the information which is recorded in the volume correspondence information table T4 from the LVOL/PVOL management module 1394 (a step S1604).

The table management module 1391 creates the physical shredding management table T3P and the logical shredding management table T3L, on the basis of the information which is recorded in the file information table T1, and the information which is recorded in the volume correspondence information table T4 (a step S1605).

Moreover, the table management module 1391 creates the PVOL information table T2P on the basis of the physical shredding management table T3P, creates the PVOL information table T2P, and also creates the LVOL information table T2L on the basis of the logical shredding management table T3L (a step S1606). In the following, the flow of processing performed by this embodiment will be explained.

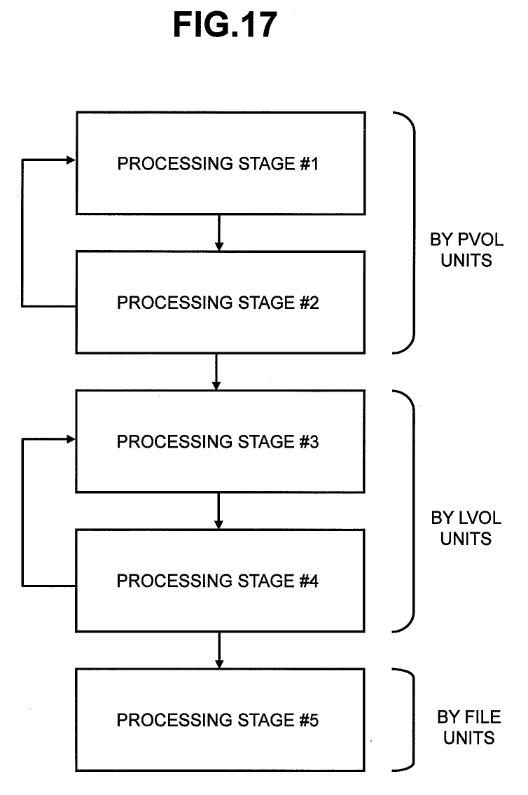

FIG. 17 shows a summary of the flow of processing performed by this embodiment.

The processing stages #1 through #5 shown in this figure are performed if a plurality of shredding subject files are present. To put it in another manner, if only one shredding subject file is present, simply the file shredding module 1132 in the archive management server 101 performs file shredding upon this one shredding subject file.

If a plurality of shredding subject files are present for the processing in PVOL units, a processing stage #1 and a processing stage #2 are performed. In the processing stage #1, a decision is made as to whether or not there exists a PVOL pair which satisfies the condition for being an aggregation source PVOL and an aggregation destination PVOL (in the following, this will be termed the “aggregation decision P”). If the result of this aggregation decision P is affirmative, the non-shredding subject file group upon the aggregation source PVOL is overwritten over the shredding subject file group upon the aggregation destination PVOL. And, in the processing stage #2, if the result of the aggregation decision P was affirmative, PVOL shredding is performed upon the aggregation source PVOL, and the processing stage #1 is performed again; while on the other hand, if the result of the aggregation decision P was negative, the processing in LVOL units is performed.

Next, for the processing in LVOL units, a processing stage #3 and a processing stage #4 are performed. In the processing stage #3, a decision is made as to whether or not there exists a LVOL pair which satisfies the condition for being an aggregation source LVOL and an aggregation destination LVOL (in the following, this will be termed the “aggregation decision L”). If the result of this aggregation decision L is affirmative, the non-shredding subject file group upon the aggregation source LVOL is overwritten over the shredding subject file group upon the aggregation destination LVOL. And, in the processing stage #4, if the result of the aggregation decision L was affirmative, LVOL shredding is performed upon the aggregation source LVOL, and the processing stage #3 is performed again; while on the other hand, if the result of the aggregation decision L was negative, the processing in file units is performed.

Finally, for the processing in file units, a processing stage #5 is performed. In this processing stage #5, file shredding is performed upon any of the shredding subject files which were not deleted either in the processing stage #2 or in the processing stage #4.

In the following, each of these processing stages #1 through #5 will be explained in detail.

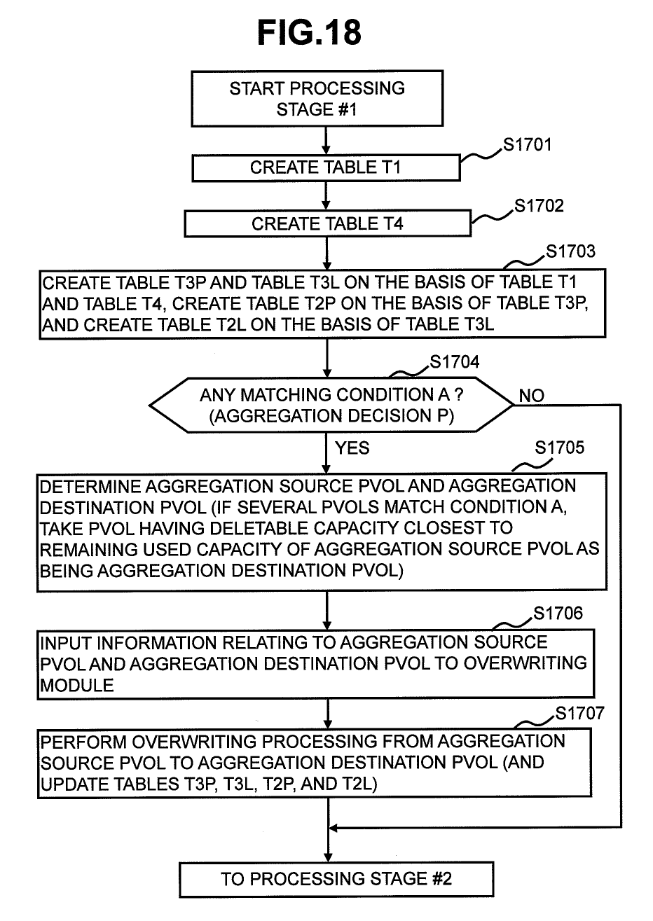

FIG. 18 shows the flow of the processing stage #1.

In a step S1701, the file/volume management module 1132 creates the file information table T1. If the situation at the time point that this processing stage #1 starts is that shown in FIG. 4, the contents of the table T1 created here are those of the table T1 shown in FIG. 12. It should be understood that the shredding subject files are, for example, files which have been stored for more than their storage periods.

In a step S1702, the LVOL/PVOL management module 1394 creates the volume correspondence information table T4. If the situation at the time point that this processing stage #1 starts is that shown in FIG. 4, the contents of the table T4 created here are those of the table T4 shown in FIG. 13.

In a step S1703, the table management module 1391 receives the information recorded in the file information table T1 from the file/volume management module 1132 via the archive/storage cooperation module 1381, and moreover acquires the information recorded in the volume correspondence information table T4. And, on the basis of the information recorded in the file information table T1 and the information recorded in the volume correspondence information table T4, the table management module 1391 creates the physical shredding management table T3P and the logical shredding management table T3L. Moreover, on the basis of his physical shredding management table T3P, the table management module 1391 creates the PVOL information table T2P, and furthermore creates the LVOL information table T2L on the basis of the logical shredding management table T3L. Since the contents of the tables T3P and T3L which are created in this step S1703 are created on the basis of the information recorded in the table T1 as shown in FIG. 12 and the information recorded in the table T4 as shown in FIG. 13, accordingly the contents of the table T3P become as shown in FIG. 14A and the contents of the table T3L becomes as shown in FIG. 14B. Moreover, since the contents of the table T2P created in this step S1703 are created on the basis of the table T3P shown in FIG. 14A, accordingly the contents of the table T2P become as shown in FIG. 15A; and, since the contents of the table T2L are created on the basis of the table T3L shown in FIG. 14B, accordingly the contents of the table T2L become as shown in FIG. 15B.

In a step S1704, the processing decision module 1393 performs the aggregation decision P described above. In concrete terms, the processing decision module 1393 decides whether or not a pair of PVOLs which satisfy the condition A are present, among the plurality of PVOLs which are registered in the table T2P. By a pair of PVOLs which satisfy the condition A, is meant a pair of PVOLS, one of which has a deletable capacity which is greater than or equal to the remaining used capacity of the other. If the result of this aggregation decision P is affirmative (YES in the step S1704), the flow of control proceeds to a step S1705, whereas if the result of this aggregation decision P is negative (NO in the step S1704), the flow of control proceeds to the next processing stage #2.

In the step S1705, the aggregation volume decision module 1392 takes some PVOL as being the aggregation source PVOL, and a PVOL which satisfies the condition A as being the aggregation destination PVOL. If there are two are two or more PVOLs which match the condition A from among these two or more PVOLs, that PVOL whose deletable capacity is closest to the remaining used capacity of some PVOL is selected. The meaning of “the deletable capacity is closest to the remaining used capacity” includes the deletable capacity being the same as the remaining used capacity. In this step S1705, for example, the PVOL 2222 shown in FIG. 4 may be selected as the aggregation source PVOL, and the PVOL 1111 shown in FIG. 4 may be selected as the aggregation destination PVOL.

In a step S1706, the processing decision module 1393 inputs information related to the aggregation source PVOL 2222 and information related to the aggregation destination PVOL 1111 to the overwriting module 1395. The information which is inputted here may be, for example, the LUN corresponding to the LVOL which this PVOL possesses, information which specifies whether or not the files which are stored upon the LUN are subjects for shredding, the LBAs corresponding to the blocks in which the data element groups which make up the file stored upon the PVOL are stored, and so on.

And, in a step S1707, the overwriting module 1395 performs overwriting processing from the aggregation source PVOL to the aggregation destination PVOL, on the basis of the information which has been inputted from the processing decision module 1393; in concrete terms, processing is performed to write the data element groups which make up the non-shredding subject file groups upon the aggregation source PVOL to the are upon the aggregation destination PVOL in which are stored the data element groups which constitute the shredding subject file group. In yet more concrete terms, as for example explained with reference to FIGS. 4 and 5, the overwriting module 1395 writes the data element groups which make up the non-shredding subject files F and H upon the aggregation source PVOL 2222 to the are (hereinafter termed the “shredding subject are A”) in which are stored the data element groups which make up the shredding subject file A upon the aggregation destination PVOL 1111. Due to this, the file A is overwritten with the files F and H. It should be understood that, while it would also be acceptable for the are in which the file C is stored (the shredding subject are C) to be employed as the shredding subject are which is the destination for writing of the files F and H, in this embodiment, as much as possible, overwriting is performed by units of files. In other words, in this embodiment, among the one or more shredding subject areas (areas in which shredding subject files are stored) which are present upon the aggregation destination PVOL, as the destination for overwriting of the one or more non-shredding subject files upon the aggregation source PVOL, that shredding subject are is employed whose storage capacity is the same as, the total amount of the one or more non-shredding subject files.

After the step S1707, the processing stage #2 is performed.

Due to the overwriting (copying) shown in FIGS. 4 and 5 being performed in the step S1707, the processing described below is performed by the table management module 1391:

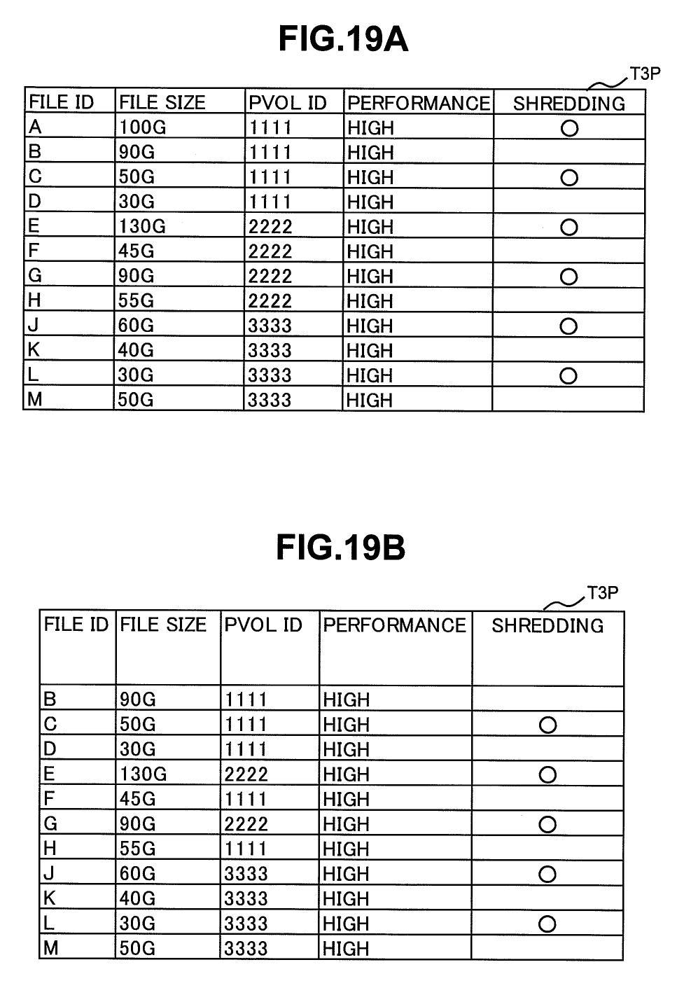

(1707-1) the table T3P is updated from the table T3P shown in FIG. 14A to the table T3P shown in FIG. 19;

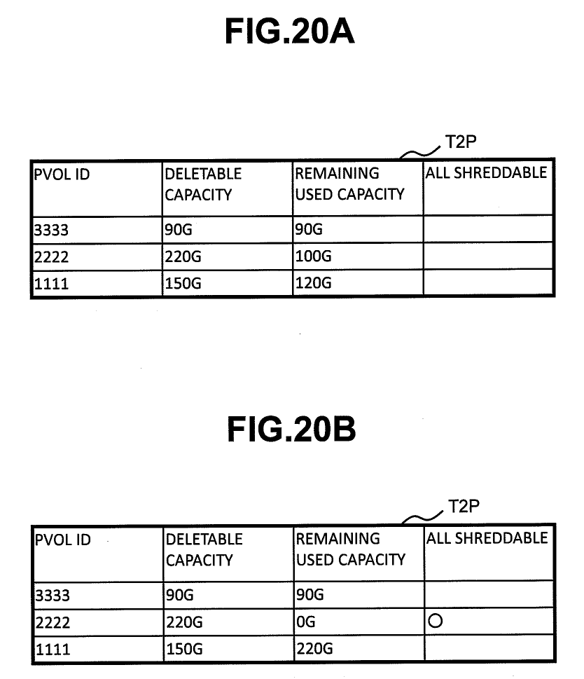

(1707-2) the table T2P is updated from the table T2P shown in FIG. 15A to the table T2P shown in FIG. 20 (in the field of the “all shreddable” flag which is recorded corresponding to the aggregation source PVOL 22, a value is set which means that PVOL shredding is possible (the “◯” mark in FIG. 20));

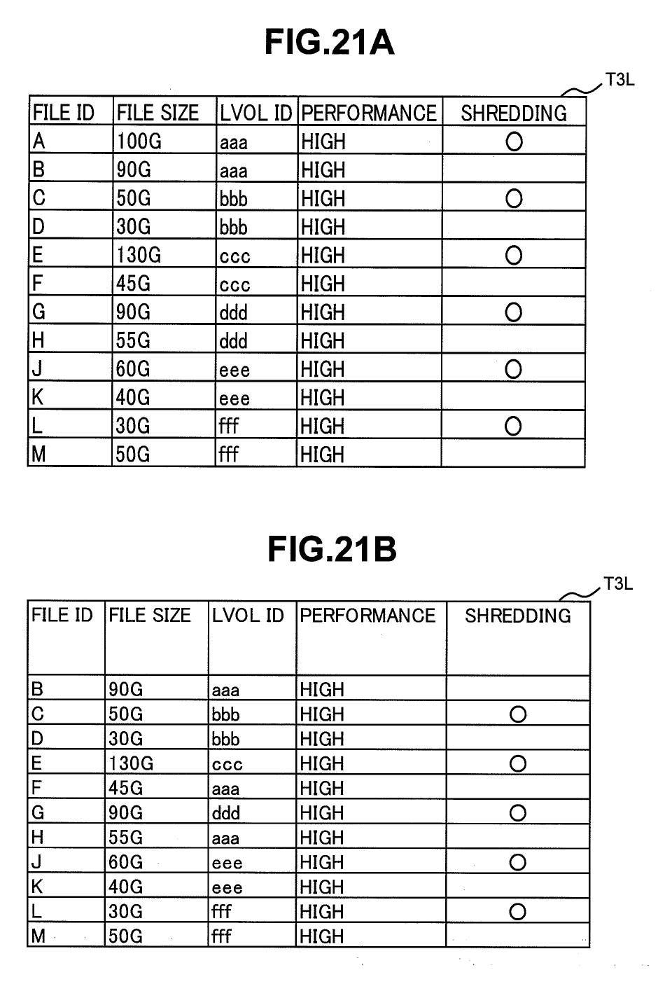

(1707-3) the table T3L is updated from the table T3L shown in FIG. 14B to the table T3L shown in FIG. 21;

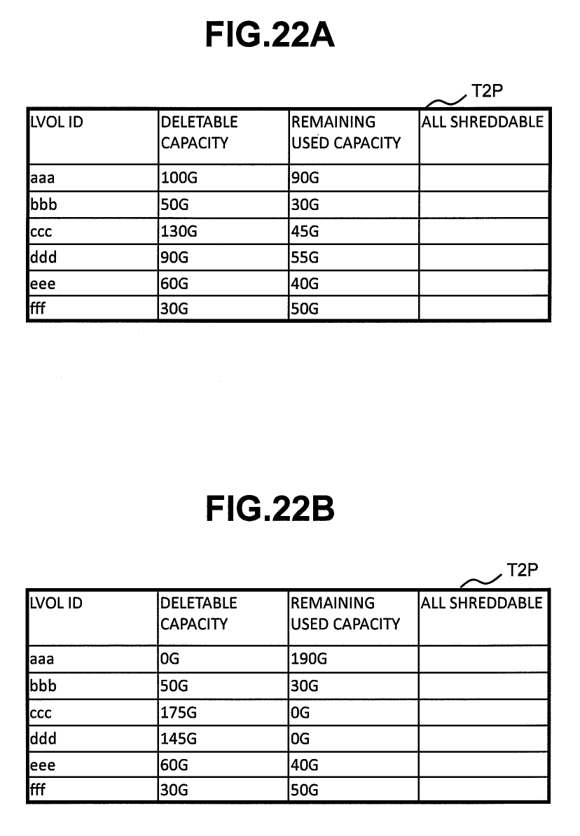

(1707-4) the table T2L is updated from the table T2L shown in FIG. 15B to the table T2L shown in FIG. 22.

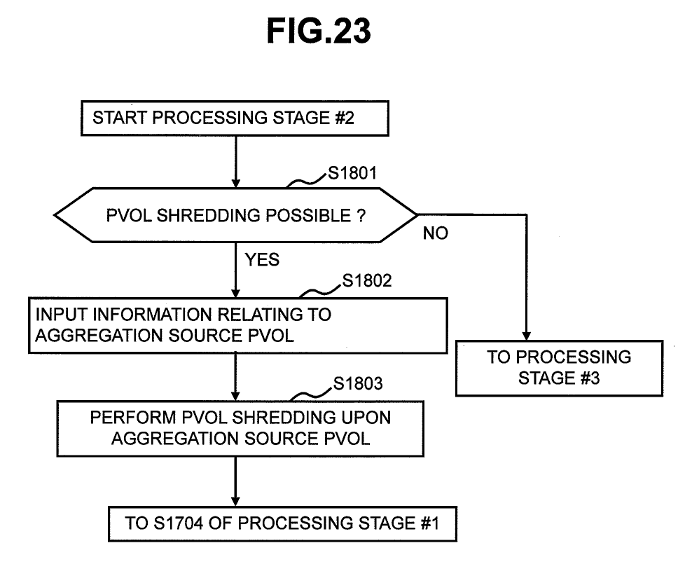

FIG. 23 shows the flow of the processing stage #2.

In a step S1801, the processing decision module 1393 decides whether or not PVOL shredding is possible. In concrete terms, the processing decision module 1393 decides whether or not any record is included in the table T2P after updating, for which a value is set is set in the field for the “all shreddable” flag which means that PVOL shredding is possible. If the result of this decision in this step S1801 is affirmative (YES in the step S1801), the step S1802 is performed, whereas, if the result of the decision in this step S1801 is negative (NO in the step S1801), the processing stage #3 is performed.

In the step S1802, the processing decision module 1393 inputs to the PVOL shredding module 1397 information (for example, the PVOL ID) related to the PVOLs upon which PVOL shredding can be performed (i.e. the PVOLs which correspond to records for which a value is set in the “all shreddable” flag field which means that PVOL shredding can be performed).

And, in the step S1803, on the basis of the information which has been inputted, the PVOL shredding module 1397 performs shredding processing in PVOL units upon the aggregation source PVOL. In concrete terms, for example, the PVOL shredding module 1397 transmits a shredding command in which the PVOL ID of the aggregation source PVOL is included to the storage system 106, and, in response to this shredding command, the CTL within the storage system 106 transmits shredding commands to all of the PDEVs which make up the aggregation source PVOL which corresponds to the PVOL ID within this command (or the CTL 151 performs shredding processing for each of the PDEVs). Or, the PVOL shredding module 1397 may transmit shredding commands to all of the PDEVs which make up the aggregation source PVOL. Upon receipt of these shredding commands, each of these PDEVs performs shredding processing. By the method described above, shredding processing is performed upon each of the PDEVs which make up the aggregation source PVOL.

Due to the shredding processing being performed in the step S1803, the processing described below is performed by the table management module 1391:

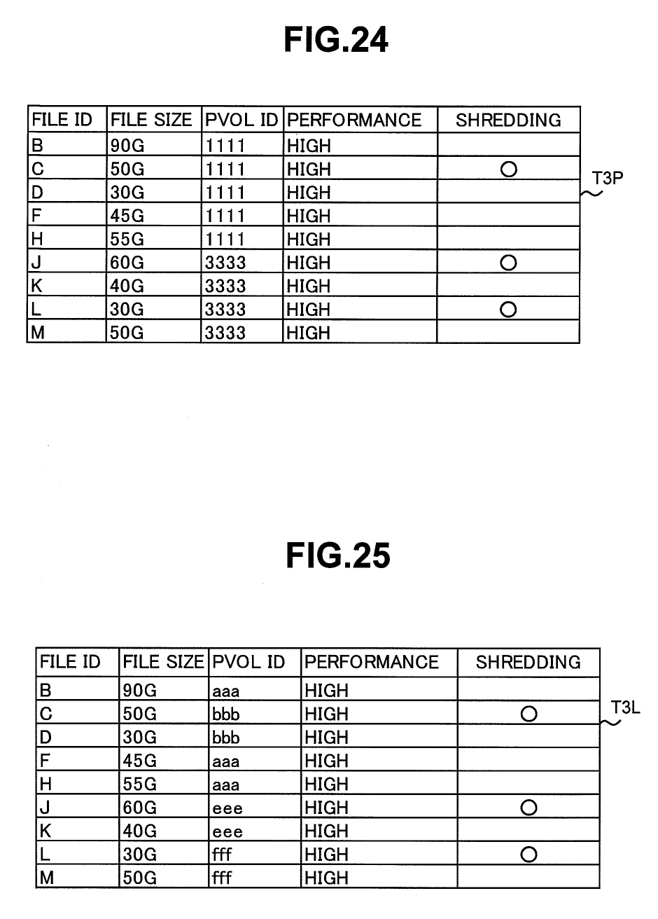

(1803-1) the table T3P is updated from the table T3P shown in FIG. 19 to the table T3P shown in FIG. 24;

(1803-2) the table T3L is updated from the table T3L shown in FIG. 21 to the table T3L shown in FIG. 25;

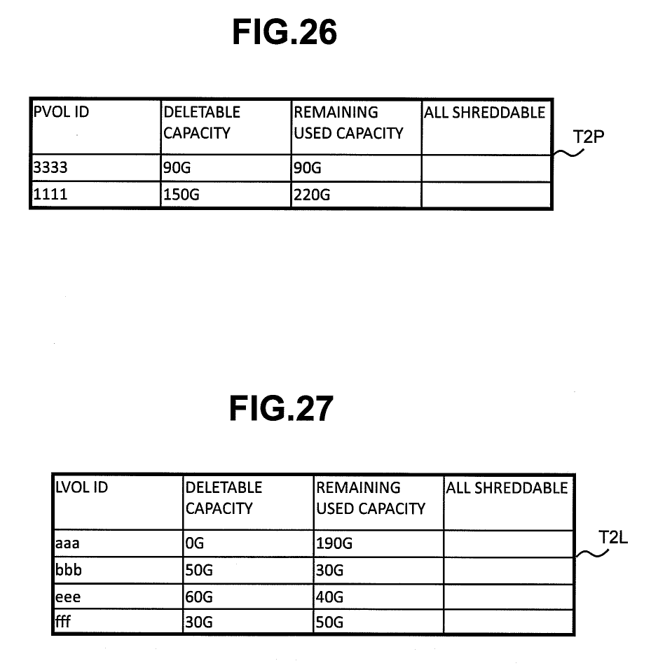

(1803-3) the table T2P is updated from the table T2P shown in FIG. 20 to the table T2P shown in FIG. 26;

(1803-4) the table T2L is updated from the table T2L shown in FIG. 22B to the table T2L shown in FIG. 27.

After this step S1803, the step S1704 of the processing stage #1 is performed on the basis of the table T2P after updating. Since, according to the table T2P shown in FIG. 26, the result of the aggregation decision P in the step S1704 is negative, therefore the result of the decision in the step S1801 of the processing stage #2 is NO, and the processing stage #3 is performed.

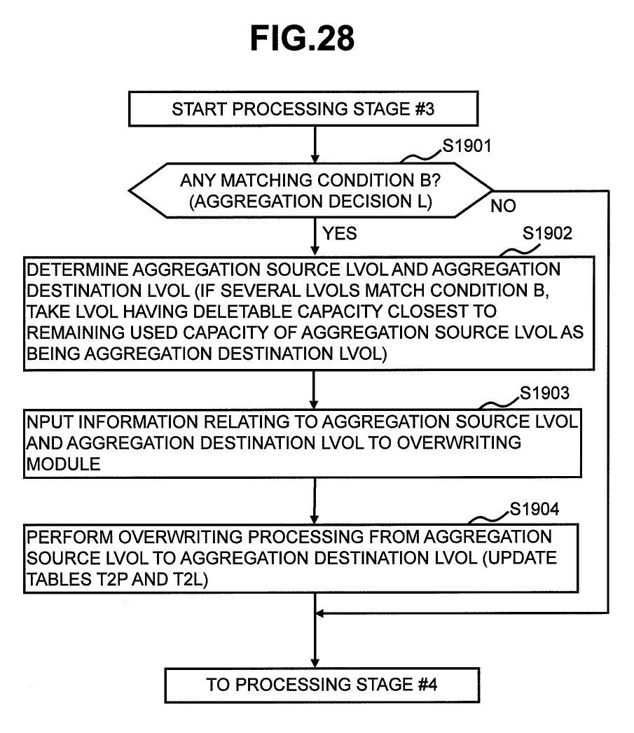

FIG. 28 shows the flow of the processing stage #3.

In a step S1901, the processing decision module 1393 performs the aggregation decision L described previously. In concrete terms, the processing decision module 1393 decides whether or not, in the plurality of LVOLs which are registered in the table T2L after updating, any LVOL exists which matches the condition B. By a LVOL which matches the condition B, is meant a LVOL which has a deletable capacity which is greater than or equal to the remaining used capacity of some LVOL. If the result of this aggregation decision L is affirmative (YES in the step S1901), the step S1902 is performed, whereas, if the result of this aggregation decision L is negative (NO in the step S1901), the processing stage #4 is performed.

In the step S1902, the aggregation volume decision module 1392 takes some LVOL as the aggregation source LVOL, and some LVOL which matches the condition B as the aggregation destination LVOL. If there are two or more LVOLs which match the condition B among these two or more LVOLs, that LVOL whose deletable capacity is closest to the remaining used capacity of the some LVOL is selected. For example, in this step S1902, the LVOL fff shown in FIG. 6 may be selected as the aggregation source LVOL, and the LVOL bbb shown in FIG. 6 may be selected as the aggregation destination LVOL.

In a step S1903, the processing decision module 1393 inputs information related to the aggregation source LVOL fff and information related to the aggregation destination LVOL bbb to the overwriting module 1395. The information which is inputted here may be, for example, the LUN corresponding to the LVOL, information which specifies whether or not the files which are stored upon the LVOL are subjects for shredding, the LBAs corresponding to the blocks in which the data element groups which make up the file stored upon the LVOL are stored, and so on.

And, in a step S1904, the overwriting module 1395 performs overwriting processing from the aggregation source LVOL to the aggregation destination LVOL, on the basis of the information which has been inputted from the processing decision module 1393; in concrete terms, processing is performed to write the data element groups which make up the non-shredding subject file groups upon the aggregation source LVOL to the are upon the aggregation destination LVOL in which are stored the data element groups which constitute the shredding subject file group. In yet more concrete terms, as for example explained with reference to FIGS. 6 and 7, the overwriting module 1395 writes the data element groups which make up the non-shredding subject file M upon the aggregation source LVOL fff to the shredding subject are upon the aggregation destination LVOL bbb in which are stored the data element groups which make up the shredding subject file C. Due to this, the file C is overwritten with the file M.

After the step S1904, the processing stage #4 is performed.

Due to the overwriting (copying) processing shown in FIGS. 6 and 7 being performed in the step S1904, the processing described below is performed by the table management module 1391:

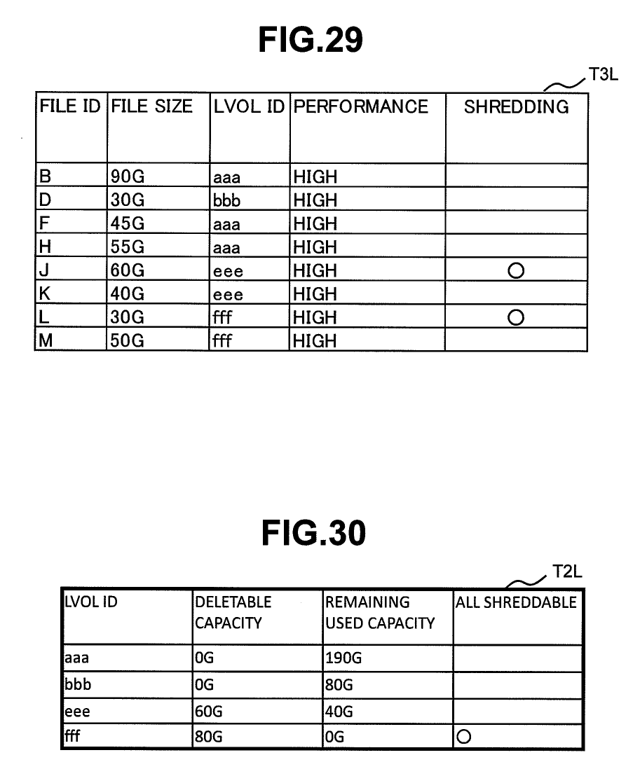

(1904-1) the table T3L is updated from the table T3L shown in FIG. 25 to the table T3L shown in FIG. 29;

(1904-2) the table T2L is updated from the table T2L shown in FIG. 27 to the table T2L shown in FIG. 30 (in the field of the “all shreddable” flag which is recorded corresponding to the aggregation source LVOL fff, a value is set which means that LVOL shredding is possible).

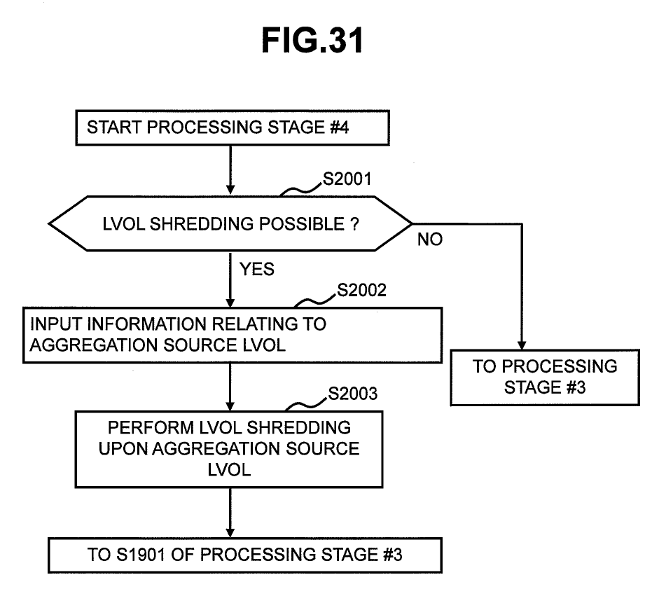

FIG. 31 shows the flow of the processing stage #4.

In a step S2001, the processing decision module 1393 decides whether or not LVOL shredding is possible. In concrete terms, the processing decision module 1393 decides whether or not any record is included in the table T2L after updating, for which a value is set is set in the field for the “all shreddable” flag which means that LVOL shredding is possible. If the result of this decision in this step S2001 is affirmative (YES in the step S2001), the step S2002 is performed, whereas, if the result of the decision in this step S2001 is negative (NO in the step S2001), the processing stage #5 is performed.

In the step S2002, the processing decision module 1393 inputs to the LVOL shredding module 1396 information (for example, the LVOL ID) related to the LVOLs upon which LVOL shredding can be performed (i.e. the LVOLs which correspond to records for which a value is set in the “all shreddable” flag field which means that LVOL shredding can be performed).

And, in the step S2003, on the basis of the information which has been inputted, the LVOL shredding module 1396 performs shredding processing in LVOL units upon the aggregation source LVOL. In concrete terms, for example, the LVOL shredding module 1396 transmits a shredding command to the storage system 106 in which the LUN which corresponds to the LVOL ID of the aggregation source LVOL is included, and, in response to this shredding command, the CTL within the storage system 106 performs shredding processing upon the aggregation source LVOL which corresponds to the LUN in this command.

Due to the shredding processing being performed in the step S2003, the processing described below is performed by the table management module 1391:

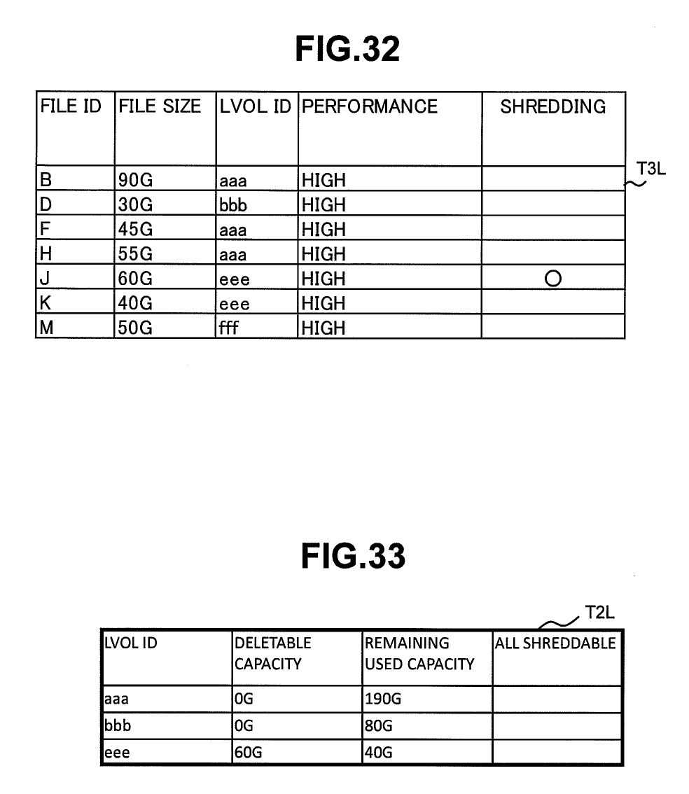

(2003-1) the table T3L is updated from the table T3L shown in FIG. 29 to the table T3L shown in FIG. 32;

(2003-2) the table T2L is updated from the table T2L shown in FIG. 30 to the table T2L shown in FIG. 33;

After this step S2003, the step S1901 of the processing stage #3 is performed on the basis of the table T2L after updating. Since, according to the table T2L shown in FIG. 33, the result of the aggregation decision L in the step S1901 is negative, therefore the result of the decision in the step S2001 of the processing stage #4 is NO, and the processing stage #4 is performed.

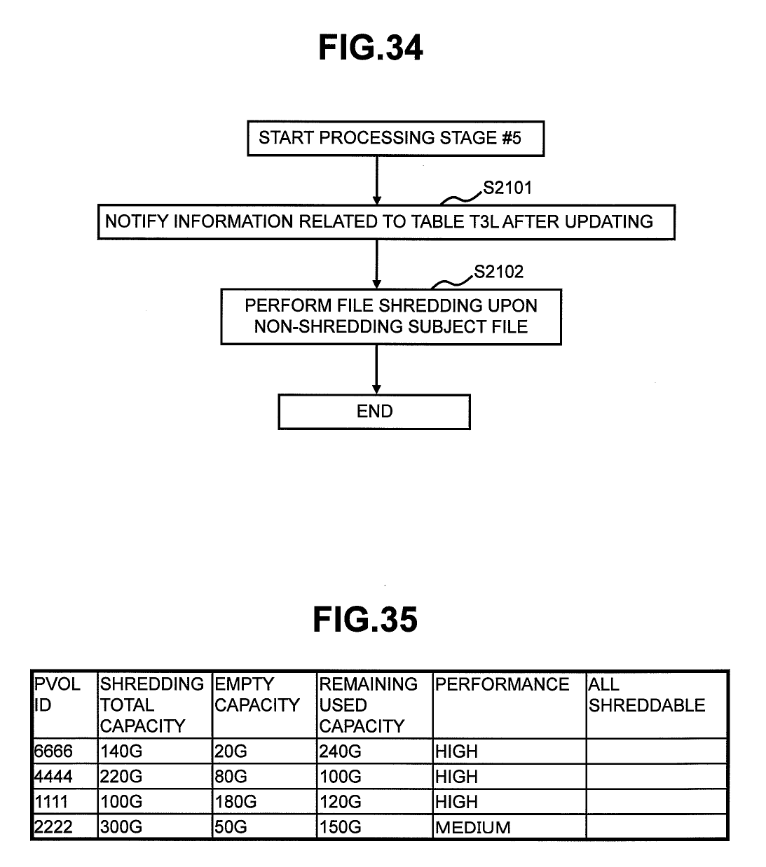

FIG. 34 shows the flow of the processing stage #5.

In a step S2101, the table management module 1391 inputs the information which is recorded in the table T3L after the updating in (2003-1) to the archive/storage cooperation module 1381, and the archive/storage cooperation module 1381 notifies the information which is recorded in the table T3L after updating to the archive administration manager 113.

And, in a step S2102, the file shredding module 1131 specifies the shredding subject files (the file J) from the information which is recorded in the table T3L after the updating in (2003-1), and issues a shredding command to the storage business server 103 in which these shredding subject files which have been specified are designated. And, on the basis of this shredding command received from the file shredding module 1131, the archive/storage cooperation module 1381 of the storage business server 103 performs file shredding processing upon the shredding subject files designated in this command. Due to this, as explained for example with reference to FIGS. 8 and 9, file shredding processing is performed upon the shredding subject file J, which was not deleted by either the PVOL shredding or the LVOL shredding.

According to the embodiment described above, shredding processing is performed by PVOL units and/or LVOL units, which are larger than files. This PVOL shredding and LVOL shredding does not need to be performed by the archive business server 101. Due to this, it is possible to alleviate the load upon the archive business server 101.

Moreover, in this PVOL shredding and LVOL shredding, while the shredding subject areas are larger than during shredding processing by file units, the shredding processing is performed in a more efficient manner than when performing shredding upon each of a plurality of shredding subject files individually. Due to this, it is possible to anticipate that the time period required for shredding all of the shredding subject files will be shortened.

Moreover, in this embodiment, the shredding subject files are not all collected together into one volume, but rather, by overwriting non-shredding subject files upon the aggregation source volume upon the shredding subject files upon the aggregation destination volume, it may be anticipated that the remaining used capacity upon the aggregation source volume is made to be zero. Due to this, it is possible to keep the number of files that are shifted low, and accordingly it is possible to make a contribution to the shortening of the time period which is required for shredding all of the shredding subject files.

Although in the above the present invention has been explained in terms of a preferred embodiment thereof, the present invention is not to be considered as being limited to that embodiment; it goes without saying that various changes are possible, provided that the gist of the present invention is not departed from. For example while, in the embodiment described above, the overwritable capacity was=to the deletable capacity, it would also be acceptable for the overwritable capacity to be=to the deletable capacity+the empty capacity (in concrete terms, for example, it would be acceptable to provide a column for the empty capacity in the table T2P (T2L), as shown in FIG. 35). In this case, even in the case of a PVOL which has less deletable capacity than the remaining used capacity of some VOL, if the capacity obtained by adding the empty capacity to the deletable capacity becomes greater than or equal to the remaining used capacity of some PVOL, this may be determined as being the aggregation destination volume. In other words, it is possible to anticipate that the possibility will be reduced of it being (undesirably) decided that no VOL pair exists which matches the condition for being an aggregation source volume and an aggregation destination volume.

And, for example, to the condition for being the aggregation source volume and the aggregation destination volume (i.e., to put it in another manner, to the condition A and/or the condition B described above), it would also be acceptable to add the condition that the performance of the aggregation destination volume is greater than or equal to the performance of the aggregation destination volume. In this case, to explain with the example of FIG. 35, it is possible to make sure that the PVOL 2222 (whose performance is “medium”) is not selected as an aggregation destination for the aggregation source PVOL 1111 (whose performance is “high”). By doing this, it is possible to prevent the performance in relation to accessing files which have been overwritten from dropping undesirably.

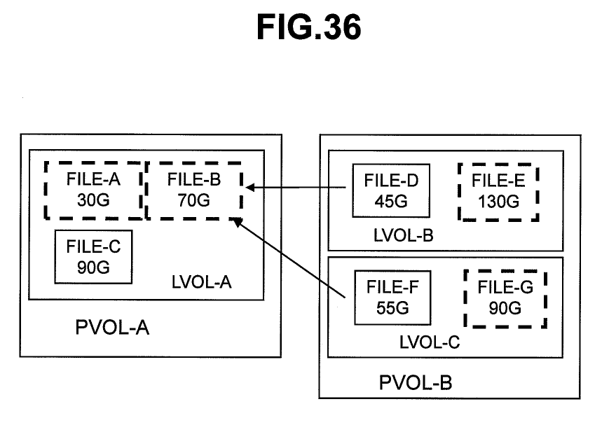

Moreover, for example, as shown in FIG. 36, it would also be acceptable to overwrite a plurality of shredding subject files F and H with an are in which a plurality of non-shredding subject files A and X are stored. In other words, it will be acceptable, provided that the capacity of the storage are which is the destination for overwriting is greater than or equal to the capacity of the storage are which is the source for overwriting.

Moreover, the deletion processing in file units is not limited to being shredding processing; for example, it would also be acceptable to employ some other type of deletion processing, such as formatting processing or the like. In concrete terms, for example, it would be acceptable to perform deletion processing which imposes a very high load (i.e. shredding processing) upon shredding subject files of very great importance for which the desired level of security is strong, while, on the other hand, performing deletion processing which imposes a lower load but for which the security level is lower, upon shredding subject files which have a lower importance.

What is claimed is:

1. A storage management device which receives a file access request from a file management device, and, in response to said file access request,
accesses any one of files stored in any one of a plurality of storage resources possessed by a storage system, comprising:
a file copy module that performs file copy processing in which files are copied between storage resources;
and a deletion processing module that, if the result of said file copy processing is that among said plurality of storage resources there is some storage resource which can be deleted, which is a storage resource upon which only files which can be deleted are stored, performs deletion processing upon said storage resource which can be deleted.

2. A storage management device according to claim 1, wherein:
as said plurality of storage resources, there are a plurality physical volumes and a plurality of logical volumes;
the physical volumes comprise one or more physical storage devices, and constitute the basis for one or more logical volumes;
(2-A-1) said file copy module performs first file copy processing, and, in said first file copy processing, reads from a first physical volume data element groups making up all of one or more files which are not subjects of deletion, and overwrites said data element groups which have been read, over data element groups making up one or more files which are subjects of deletion upon a second physical volume;
(2-A-2) if the result of said first file copy processing is that only files which can be deleted are stored upon said first physical volume, said deletion processing module performs, as said deletion processing, shredding processing is performed upon said first physical volume which now has become a storage resource which can be deleted;
(2-B-1) said file copy module performs second file copy processing, and, in said second file copy processing, reads from a first logical volume data element groups making up all of one or more files which are not subjects of deletion, and overwrites said data element groups which have been read, over data element groups making up one or more files which are subjects of deletion upon a second logical volume;
(2-B-2) if the result of said second file copy processing is that only files which can be deleted are stored upon said second logical volume, said deletion processing module performs, as said deletion processing, shredding processing is performed upon said second logical volume which now has become a storage resource which can be deleted;
and:
said second physical volume is a physical volume having an overwritable capacity which is greater than or equal to the remaining used capacity for said first physical volume;
said second logical volume is a logical volume having an overwritable capacity which is greater than or equal to the remaining used capacity for said first logical volume;
the overwritable capacity is either the deletable capacity, which is the total volume of the deletion subject files, or the sum of that deletable capacity and the empty capacity;
the remaining used capacity is the total volume of the non-deletion subject files; and
said files which can be deleted are either deletion subject files, or non-deletion subject files which have been the source for being read.

3. A storage management device according to claim 2, wherein:
in (2-A-2) above, after shredding processing has been performed upon said first physical volume, if there are physical volumes among said plurality of physical volumes which satisfy a condition to be a first physical volume and a second physical volume, (2-A-1) above is performed for those physical volumes, while, if there are no physical volumes among said plurality of physical volumes which satisfy said condition to be a first physical volume and a second physical volume, (2-B-1) above is performed;
in (2-B-2) above, after shredding processing has been performed upon said first logical volume, if there are logical volumes among said plurality of logical volumes which satisfy a condition to be a first logical volume and a second logical volume, (2-B-1) above is performed for those logical volumes.

4. A storage management device according to claim 2, wherein:
said second physical volume is that physical volume whose overwritable capacity is closest to the used capacity of said first physical volume; and
said second logical volume is that logical volume whose overwritable capacity is closest to the used capacity of said first logical volume.

5. A storage management device according to claim 2, wherein:
the performance of said second physical volume is greater than or equal to the performance of said first physical volume; and
the performance of said second logical volume is greater than or equal to the performance of said first logical volume.

6. A storage management device according to claim 2, wherein upon receipt from said file management device of a deletion request in which one or more deletion subject files are specified which have not been deleted by either (2-A-2) above or (2-B-2) above, in response to said deletion request, deletion processing is performed by file units upon said deletion subject files which have not been deleted by either (2-A-2) above or (2-B-2) above.

7. A storage management device according to claim 2, further comprising:
an information management module; and
a second volume determination module;
and wherein:
before said first file copy processing in (2-A-1) above, on the basis of file management information at the most recent time point, which is information which specifies, for each file, what its size is and on which logical volume it is stored and whether or not it is a subject for deletion, and of volume correspondence management information, which is information which specifies, for each logical volume, what its size is and on which physical volume or volumes of what sizes it is based, said information management module: creates physical deletion management information which specifies which files of what sizes on which physical volumes are subjects for deletion, and logical deletion management information which specifies which files of what sizes on which logical volumes are subjects for deletion; creates, on the basis of said physical deletion management information, physical volume management information which specifies, for each physical volume, an overwritable capacity and a remaining used capacity; and creates, on the basis of said logical deletion management information, logical volume management information which specifies, for each logical volume, an overwritable capacity and a remaining used capacity;
said second volume determination module determines said second physical volume for said first physical volume, on the basis of said physical volume management information;
before said second file copy processing in (2-B-1) above, said information management module updates said logical deletion management information and said logical volume management information on the basis of said first file copy processing and shredding processing upon said first physical volume; and
said second volume determination module determines said second physical volume for said first physical volume, on the basis of said logical volume management information after updating.

8. A storage management device according to claim 1, wherein:
in said file copy processing, said file copy module reads from a first storage resource data element one or more groups which make up one or more non-deletion subject files, and overwrites said data element groups which have been read over one or more data element groups which make up one or more deletion subject files upon a second data resource;
if the only files which are stored upon said first storage resource are files which can be deleted, said deletion processing module performs deletion processing upon said first storage resource;
said second storage resource is a storage resource having an overwritable capacity which is greater than or equal to the remaining used capacity for said first storage resource;
the overwritable capacity is either the deletable capacity, which is the total volume of the deletion subject files, or the sum of that deletable capacity and the empty capacity;
the remaining used capacity is the total volume of the non-deletion subject files; and
said files which can be deleted are either deletion subject files, or non-deletion subject files which have been the source for being read.

9. A storage management device according to claim 1, wherein said second storage resource is that storage resource whose overwritable capacity is closest to the used capacity of said first storage resource.

10. A storage management device according to claim 1, wherein the performance of said second storage resource is greater than or equal to the performance of said first storage resource.

11. A storage management device according to claim 1, wherein, upon receipt from said file management device of a deletion request in which one or more deletion subject files are specified which have not been deleted by said deletion processing module, in response to said deletion request, deletion processing is performed upon the are in which said deletion subject files which have not been deleted by said deletion processing module are stored.

12. A file deletion control method, wherein:
file copy processing is performed in which files are copied between storage resources possessed by a storage system; and
if the result of said file copy processing is that among said plurality of storage resources possessed by said storage system, there is some storage resource which can be deleted, which is a storage resource upon which only files which can be deleted are stored, deletion processing is performed upon said storage resource which can be deleted.

13. A file deletion control method, wherein:
(13-1) a first physical volume and a second physical volume are determined from a plurality of physical volumes possessed by a storage system and first file copy processing is performed, and, in said first file copy processing, data element groups which make up all non-deletion subject files are read from said first physical volume, and said data element groups which have been read are overwritten over data element groups which make up deletion subject files upon said second physical volume;
(13-2) if the result of said first file copy processing is that only files which can be deleted are stored upon said first physical volume, shredding processing is performed upon said first physical volume as a physical volume unit;
(13-3) after (13-2) above, if there are any further physical volumes among said plurality of physical volumes which satisfy the condition to be said first and said second physical volumes, (13-1) above is performed; while, if there are no further physical volumes among said plurality of physical volumes which satisfy the condition to be said first and said second physical volumes, (13-4) below is performed;
(13-4) a first logical volume and a second logical volume are determined from a plurality of logical volumes which are based upon said plurality of physical volumes and second file copy processing is performed, and, in said second file copy processing, data element groups which make up all non-deletion subject files are read from said first logical volume, and said data element groups which have been read are overwritten over data element groups which make up deletion subject files upon said second logical volume;
(13-5) if the result of said second file copy processing is that only files which can be deleted are stored upon said first logical volume, shredding processing is performed upon said first logical volume as a logical volume unit;
(13-6) after (13-5) above, if there are any further logical volumes among said plurality of logical volumes which satisfy the condition to be said first and said second logical volumes, (13-4) above is performed; while, if there are no further logical volumes among said plurality of logical volumes which satisfy the condition to be said first and said second logical volumes, (13-7) below is performed; and
(13-7) deletion processing by file units is performed upon any deletion subject files which have not been deleted by either (13-2) above or (13-5) above;
the physical volumes comprise one or more physical storage devices;
said second physical volume is a physical volume having an overwritable capacity which is greater than or equal to the remaining used capacity for said first physical volume;
said second logical volume is a logical volume having an overwritable capacity which is greater than or equal to the remaining used capacity for said first logical volume;
the overwritable capacity is either the deletable capacity, which is the total volume of the deletion subject files, or the sum of that deletable capacity and the empty capacity;
the remaining used capacity is the total volume of the non-deletion subject files; and
said files which can be deleted are either deletion subject files, or non-deletion subject files which have been the source for being read.
